(19) United States
(12) Patent Application Publication
(10) Pub. No.: US 2024/0265065 A1
(43) Pub. Date: Aug. 8, 2024

(54) Automated Classification Pipeline

(71) Applicant: Wise Tech Global Limlted, Alexandria, New South Wales (AU)

(72) Inventors: Ronald Jay Lackey, Alexandria (AU); James Anthony Hardenburgh, Alexandria (AU); Amish Sheth, Alexandria (AU); Richard White, Alexandria (AU)

(21) Appl. No.: 18/567,321

(22) PCT Filed: Jun. 3, 2022
(86) PCT No.: PCT/AU2022/050551

§ 371 Date: Dec. 5, 2023

Related U.S. Application Data
(60) Provisional application No. 63/197,378, filed on Jun. 5, 2021.

(30) Foreign Application Priority Data
Dec. 20, 2021 (AU) 2021904134

(51) Int. Cl. G06F 18/2415; G06F 9/451

(52) U.S. Cl. CPC G06F 18/2415; G06F 9/451

(57) ABSTRACT

This disclosure relates to a computer system for classifying a product into a tariff classification, which is represented by a node in a tree of nodes. A data store stores the tree of nodes, each node being associated with a text string indicative of a semantic description of that node as a sub-class of a parent of that node, and multiple classification components, each having a product characterisation as input and a classification into one of the nodes as an output. A processor iteratively selects one of the multiple classification components based on a current classification of the product, and applies the one of the multiple classification components to the product characterisation to update the current classification of the product. The processor further outputs, responsive to meeting a termination condition, the current classification as a final classification of the product.

### CROSS-REFERENCE TO RELATED APPLICATIONS

The present application claims priority from Australian Provisional Patent Application No 2021904134 filed on 20 Dec. 2021 and U.S. Provisional Patent Application No. 63/197,378 filed on 5 Jun. 2021, the contents of which are incorporated herein by reference in their entirety.

### TECHNICAL FIELD

This disclosure relates to classifying products into a tariff classification.

### BACKGROUND

Multiclass classification is a practical approach for a range of classification tasks. For example, images can be classified into one of multiple classes. That is, the classifier does not output only a binary classification, such as yes/no for containing a cat. Instead, a multiclass classifier outputs one of multiple classes, such as cat, dog, car, etc. As a further example, in robot awareness where the current situation in which the robot finds itself can be classified as one of multiple pre-defined situations (i.e. ‘classes’).

Some machine learning methods can be adapted to perform multiclass classification. For example, a neural network can have multiple output nodes and the output node with the highest calculated value represents the class that is chosen as the output. Similarly, linear regression can be modified to provide output values for multiple classes and the maximum value determines the output class.

One problem, however, with machine learning classification is the training effort. With the increasing number of output classes, the number of required training samples increases. This also means the computational complexity for training increases. In many cases, the computational complexity increases above linearly or even exponentially. This makes many applications with a high number of classifications impractical due to the immense size of the required training set as well as the impractical computation time for training.

One particularly difficult example of multiclass classification is tariff classification. In that discipline, a product ought to be classified into the correct tariff classification. In the United States, there are about 19,000 distinct classification codes. This would require a multiclass classifier with 19,000 possible output classes.

There are two different approaches for adapting a binary classifier to multiclass classification. The first approach is One-Vs-Rest, where a binary classifier is created for each output class and each classifier classifies between its output class and all other output classes. So for classes 1, 2, 3, there would be three classifiers classifying between 1/[2,3], 2/[1,3] and 3/[1,2]. With 19,000 output classes, however, it is difficult to train each classifier because with a balanced dataset, each classifier would at least require an accuracy of 1−1/19,000=99.99% to be better than a zero classifier that classifies all inputs into the same output. The number of training samples and computational time to achieve this accuracy would be immense.

Another approach is the one-vs-one classifier where each binary classifier distinguishes between only two of the classes. Classification is achieved by building a classifier for each combination of classes. For 4 classes, this approach would require 6 classifiers (1-2, 1-3, 1-4, 2-3, 2-4, 3-4). However, for 19,000 classes, this approach would require (19,000*(19,000−1))/2=180,490,500 classifiers. Creating and training 180 million classifiers is clearly impractical due to the required storage space for classifiers and training data, computational time required for training and for evaluation as well as energy consumption for the processing.

This shows that existing classifiers cannot be practically applied to the problem of tariff classification due to the excessive amount in computer resources that the existing algorithms require.

While this shows that there is a need for a classification method that can be applied to a large number of possible output classes, there is also a problem with smaller number of classes. More particular, any machine learning model uses training images and not always are training images available at a number that results in an accurate classification. Therefore, there is a need for a classification method that can be configured with a smaller number of training images. Using fewer training images also significantly reduces the training time.

There is yet another problem with existing classification methods in that the classification may encounter parameters in the model that have insufficient reliability or that are not defined sufficiently specific. In those cases, the classification result would still be generated, but the classification quality would be grossly inaccurate. For example, the determined output class would still be indicated, but it is difficult to determine at what stage of the classification were inaccuracies introduced. This could be a particular problem in cases where the input data, that is evaluated by the model, does not include the features that are mainly relied on by the model. Therefore, there is a need for a classification method that can deal with information that is missing from the input data to be classified and would therefore lead to wildly inaccurate classification results.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

There is provided a method for classifying a product into a tariff classification, the tariff classification being represented by anode in a tree of nodes, the method comprising:
storing the tree of nodes, each node being associated with a text string indicative of a semantic description of that node as a sub-class of a parent of that node;
storing multiple classification components, each having a product characterisation as input and a classification into one of the nodes as an output;
connecting multiple classification components based on the product characterisation into a pipeline of independent classification components, the pipeline being specific to the product classification, each classification component of the pipeline being configured to independently generate digits of the tariff classification additional to the classification output of a classification component upstream in the pipeline, by iteratively performing:
   selecting one of the multiple classification components based on a current classification of the product, and
   applying the one of the multiple classification components to the product characterisation to update the current classification of the product;
responsive to meeting a termination condition, outputting the current classification as a final classification of the product.

In some embodiments, outputting the current classification comprises generating a user interface wherein the user interface comprises an indication of a feature value for each classification component of the pipeline separately, that is determinative of the classification output of that component, and a user interaction element for the user to change the feature value to thereby cause re-creation of the pipeline of classification components downstream from the classification component for which the feature value was changed by the user interaction to update the current classification.

In some embodiments, the method further comprises re-training the classification component for which the feature value was changed using the changed feature value as a training sample for the re-training.

In some embodiments, selecting the one of the multiple classification components is further based on determining a presence of one or more keywords in the product characterisation.

In some embodiments, the multiple classification components comprise:
classification components that are applicable only if the product is unclassified; and
classification components that are applicable only if the product is partly classified.

In some embodiments, each of the classification components that are applicable only if the product is unclassified are configured to classify the product into one of multiple chapters of the tariff classification.

In some embodiments, the classification components that are applicable only if the product is unclassified comprise trained machine learning models to classify the unclassified product.

In some embodiments, selecting one of the multiple classification components comprises matching keywords defined for the multiple classification components against the product characterisation and selecting the component with an optimal match.

In some embodiments, the current classification is represented by a sequence of multiple digits and digits later in the sequence define a classification lower in the tree of nodes.

In some embodiments, the multiple classification components comprise:
multiple components for classifying the product into a 2-digits chapter; and
multiple components for classifying the product with a 2-digit classification into a 6-digit sub-heading.

In some embodiments, the termination condition comprises a minimum number of the digits.

In some embodiments, iteratively performing comprises performing at least three iterations to select at least three classification components for the product.

In some embodiments, applying the one of the multiple classification components to the product characterisation comprises:
converting the product characterisation into a vector;
test each of multiple candidate classifications in relation to the current classification against the vector;
accept one of the multiple candidate classifications based on the test.

In some embodiments, applying the one of the multiple classification components comprises:
extracting a feature value from the product categorisation; and
updating the current classification based on the feature value.

In some embodiments, extracting the feature value comprises evaluating a trained machine learning model, wherein the trained machine learning model has the product characterisation as an input, and the feature value as an output.

In some embodiments, extracting the feature value comprises selecting one of multiple options for the feature value.

In some embodiments, the method further comprises determining the multiple options for the feature value from the text string indicative of a semantic description of that node.

In some embodiments, the multiple classification components comprise a base-component and a refined-component; and the refined-component is associated with multiple options for the feature value that are inherited from the base-component.

In some embodiments, the method further comprises training the multiple classification components according to a predefined schedule.

In some embodiments, the method further comprises refining one or more of the multiple classification components for a further product based on user input related to classifying the product.

Software, when executed by a computer, causes the computer to perform the above method.

There is provided a computer system for classifying a product into a tariff classification, the tariff classification being represented by a node in a tree of nodes, the computer system comprising:
a data store configured to store:
   the tree of nodes, each node being associated with a text string indicative of a semantic description of that node as a sub-class of a parent of that node, and
   multiple classification components, each having a product characterisation as input and a classification into one of the nodes as an output; and
a processor configured to connect multiple classification components based on the product characterisation into a pipeline of independent classification components, the pipeline being specific to the product classification, each classification component of the pipeline being configured to independently generate digits of the tariff classification additional to the classification output of a classification component upstream in the pipeline, by iteratively performing:
   selecting one of the multiple classification components based on a current classification of the product, and
   applying the one of the multiple classification components to the product characterisation to update the current classification of the product;
the processor being further configured to, responsive to meeting a termination condition, outputting the current classification as a final classification of the product.

### Feature Annotation

There is provided a method for classifying a product into a tariff classification, the tariff classification being represented by a node in a tree of nodes, each node being associated with a text string indicative of a semantic description of that node as a sub-class of a parent of that node, the method comprising:
iteratively classifying, at one of the nodes of the tree, the product into one of multiple child nodes of that node;
wherein the classifying comprises:
   determining a set of features of the product that are discriminative for that node by extracting the features from the text string indicative of a semantic description of that node; and
   determining a feature value for each feature of the product by extracting the feature value from a product characterisation, and
   evaluating a decision model of that node for the determined feature values, the decision model being defined in terms of the extracted feature for that node.

In some embodiments, at a first iteration of classifying the product, the product is unclassified and classifying comprises classifying the product into one of multiple chapters of the tariff classification.

In some embodiments, classifying the unclassified product comprises applying a trained machine learning models to classify the unclassified product.

In some embodiments, a current classification at a node of the tree is represented by a sequence of multiple digits and digits of a later iteration define a classification deeper in the tree of nodes.

In some embodiments, classifying comprises one of:
classifying the product into a 2-digits chapter; and
classifying the product with a 2-digit classification into a 6-digit sub-heading.

In some embodiments, iteratively classifying comprises repeating the classifying until a termination condition is met.

In some embodiments, the termination condition comprises a minimum number of digits representing the classification.

In some embodiments, iteratively classifying comprises performing at least three classifications.

In some embodiments, classifying comprises:
converting the product characterisation into a vector;
test each of multiple candidate classifications in relation to the current classification against the vector; and
accept one of the multiple candidate classifications based on the test.

In some embodiments, extracting the feature value comprises evaluating a trained machine learning model, wherein the trained machine learning model has the product characterisation as an input, and the feature value as an output.

In some embodiments, extracting the feature value comprises selecting one of multiple options for the feature value.

In some embodiments, the method further comprises determining the multiple options for the feature value from the text string indicative of a semantic description of that node.

In some embodiments, selecting the one of the multiple options for the feature value comprises:
calculating a similarity score indicative of a similarity between each of the options and the product characterisation; and
selecting the one of the multiple options with the highest similarity.

In some embodiments, the method further comprises:
calculating a similarity score indicative of a similarity between each of the options and the product characterisation;
presenting, in the user interface, multiple of the options that have the highest similarity to the user for selection; and
receiving a selection of one of the option by the user to thereby receive the feature value.

In some embodiments, the method further comprises applying a trained image classifier to an image of the product to select the one of the multiple options for the feature value.

In some embodiments, the method further comprises performing natural language processing of the product characterisation to select the one of the multiple options for the feature value.

In some embodiments, the method further comprises training the decision model according to a predefined schedule.

In some embodiments, the method further comprises refining the decision model for a further product based on user input related to classifying the product.

Software, when performed by a computer, causes the computer to perform the above method.

There is provided a computer system for classifying a product into a tariff classification, the tariff classification being represented by a node in a tree of nodes, each node being associated with a text string indicative of a semantic description of that node as a sub-class of a parent of that node, the computer system comprising a processor configured to: iteratively classify, at one of the nodes of the tree, the product into one of multiple child nodes of that node;
wherein to classify comprises:
   determining a set of features of the product that are discriminative for that node by extracting the features from the text string indicative of a semantic description of that node; and
   determining a feature value for each feature of the product by extracting the feature value from a product characterisation, and
   evaluating a decision model of that node for the determined feature values, the decision model being defined in terms of the extracted feature for that node.

### Guided Classification

There is provided a method for classifying a product into a tariff classification, the tariff classification being represented by a node in a tree of nodes, each node being associated with a text string indicative of a semantic description of that node as a sub-class of a parent of that node, the method comprising:
iteratively classifying, at one of the nodes of the tree, the product into one of multiple child nodes of that node;
wherein the classifying comprises:
   determining whether a current assignment of feature values to features supports a classification from that node;
   upon determining that the current assignment of feature values to features does not support the classification from that node on the path, selecting one of multiple unresolved features that results in a maximum support for downstream classification;
   generating a user interface comprising a user input element for a user to enter a value for the selected one of the multiple non-valued features;
   receiving a feature value entered by the user; and
   evaluating a decision model of that node for the received feature value, the decision model being defined in terms of the extracted feature for that node.

In some embodiments, at a first iteration of classifying the product, the product is unclassified and classifying comprises classifying the product into one of multiple chapters of the tariff classification.

In some embodiments, classifying the unclassified product comprises applying a trained machine learning models to classify the unclassified product.

In some embodiments, a current classification at a node of the tree is represented by a sequence of multiple digits and digits of a later iteration define a classification deeper in the tree of nodes.

In some embodiments, classifying comprise one of:
classifying the product into a 2-digits chapter; and
classifying the product with a 2-digit classification into a 6-digit sub-heading.

In some embodiments, iteratively classifying comprises repeating the classifying until a termination condition is met.

In some embodiments, the termination condition comprises a minimum number of digits representing the classification.

In some embodiments, iteratively classifying comprises performing at least three classifications.

In some embodiments, classifying comprises:
converting the product characterisation into a vector;
test each of multiple candidate classifications in relation to the current classification against the vector; and
accept one of the multiple candidate classifications based on the test.

In some embodiments, the method further comprises extracting the feature values by evaluating a trained machine learning model, wherein the trained machine learning model has the product characterisation as an input, and the feature value as an output.

In some embodiments, extracting the feature value comprises selecting one of multiple options for the feature value.

In some embodiments, the method further comprises determining the multiple options for the feature value from the text string indicative of a semantic description of that node.

In some embodiments, each of the multiple options is associated with one or more keywords and selecting one of the multiple options comprises matching the one or more keywords against the product characterisation and selecting the best matching option.

In some embodiments, the one or more keywords comprise a strong keyword that forces a selection of the associated option when matched.

In some embodiments, the one or more keywords are included in lists of keywords that are selectable by the user for each of the options.

In some embodiments, the user interface comprises automatically generated keywords or list of keywords for the user to select for each option.

In some embodiments, the method comprises automatically generating the keywords or list of keywords by determining one or more of:
synonyms;
hyponyms; and
lemmatization.

In some embodiments, the user interface presents the automatically generated keywords or list of keywords in hierarchical manner to reflect an hierarchical relationship between the keywords or list of keywords.

In some embodiments, each classification is performed by a selected one of multiple classification components comprising a base-component and a refined-component; the refined-component is associated with multiple options for the feature value that are inherited from the base-component; and the user interface presents the multiple options and associated keywords with a graphical indication of which of the multiple options and associate keywords are inherited.

In some embodiments, selecting the one of the multiple options for the feature value comprises:
calculating a similarity score indicative of a similarity between each of the options and the product characterisation; and
selecting the one of the multiple options with the highest similarity.

In some embodiments, the method further comprises:
calculating a similarity score indicative of a similarity between each of the options and the product characterisation;
presenting, in the user interface, multiple of the options that have the highest similarity to the user for selection; and
receiving a selection of one of the option by the user to thereby receive the feature value.

Software, when performed by a computer, causes the computer to perform the above method.

There is provided a computer system for classifying a product into a tariff classification, the tariff classification being represented by a node in a tree of nodes, each node being associated with a text string indicative of a semantic description of that node as a sub-class of a parent of that node, the computer system comprising a processor configured to:
iteratively classify, at one of the nodes of the tree, the product into one of multiple child nodes of that node;
wherein to classify comprises:
   determining whether a current assignment of feature values to features supports a classification from that node;
   upon determining that the current assignment of feature values to features does not support the classification from that node on the path, selecting one of multiple unresolved features that results in a maximum support for downstream classification;
   generating a user interface comprising a user input element for a user to enter a value for the selected one of the multiple non-valued features;
   receiving a feature value entered by the user; and
   evaluating a decision model of that node for the received feature value, the decision model being defined in terms of the extracted feature for that node.

Optional features that are provided with reference to one of the aspects of method, computer system or software, are equally optional features to the other aspects.

### BRIEF DESCRIPTION OF DRAWINGS

An example will be described with reference to the following drawings:

FIG. 1 illustrates an example method for classifying a product into a tariff classification.

FIG. 2 illustrates an example tree structure.

FIG. 3 illustrates a set of components as stored by a processor.

FIG. 4 shows an example from Chapter 07 including different categories.

FIG. 5a illustrates a further example method for classifying a product into a tariff classification.

FIG. 5b illustrates yet a further method for classifying a product into a tariff classification.

FIG. 6 is a screen shot of the set of categories that have been defined for the Chapter 64 (Shoes) component.

FIG. 7 shows the categorical values configured for the upper_material feature.

FIG. 8 shows a user interface generated by the processor including multiple definitions of example words.

FIG. 9 shows an interactive user interface generated by the processor including the direct hyponyms of legume along with the hyponyms of bean/edible-bean.

FIG. 10 shows an interactive user interface generated by the processor including the hypernym of legume that is vegetable/veggie/veg and some of the direct hyponyms of this.

FIG. 11 shows an interactive user interface generated by the processor including an example of contextual words of legumes.

FIG. 12 is a screenshot of a user interface for configuring keywords.

FIG. 13 shows three screenshots that show how annotated headings of Chapter 64 are annotated using the product features.

FIG. 14 illustrates a tree view when viewing the annotation conditions for the Chapter 64 component.

FIG. 15 illustrates a user interface after clicking “Show HS Annotation Condition”.

FIG. 16 illustrates an end-to-end classification workflow as implemented by the processor.

FIG. 17 illustrates a full classification code generated by pipelining a minimum of three components.

FIG. 18 illustrates a computer system for classifying a product into a tariff classification.

FIG. 19 illustrates an example of classifying a product into a tariff classification.

FIG. 20a illustrates a training image with a positive feature value (present).

FIG. 20b illustrates a training image with a negative feature value (not present).

FIG. 20c illustrates an image classifier.

FIG. 20d illustrates a product image to be classified by the classifier shown in FIG. 20c.

### DESCRIPTION OF EMBODIMENTS

As stated above, existing multiclass classifiers require unacceptable computing resources when applied to the multiclass classification problems with a high number of classes, such as tariff classification with about 19,000 classes.

This disclosure provides methods and systems for the efficient classification into a high number of classes. It was found that in same classification tasks, the classification can be presented hierarchically in a graph structure. Further, in some classification tasks, this graph structure is annotated with text strings associated with each of the nodes. This disclosure provides methods that utilise these text strings in the graph structure to provide a classification that is highly accurate and is determined with low computational complexity. Further, the proposed classification is modular for cases where the text strings change over time. Even further, user input can be requested anywhere in the hierarchy in case the automated classification is not reliable at that particular point of the hierarchy.

In summary, the classification is significantly faster and less computer resources are required compared to existing methods.

The following paragraphs provide one example for implanting the above disclosure, noting that many other architectures and technologies may be used.

Performance can further be improved by implementing the solution using Restful micro-services that are deployed on AWS residing behind the API Gateway. Each micro-service defines its own schema in a relational Postgres SQL database except for the Product micro-service which also makes use of a No-SQL database to persist the Product and Classification entities. These two entities will reside in DynamoDB and indexed in Elastic Search by consuming DynamoDB change stream via Lambda. A backend web application and micro-services are written in Java except for the machine learning (ML) pieces which are written in Python. The UI development use Angular for data-binding along with native HTML and Javascript. The UI uses AJAX to either invoke micro-services directly or UI controller logic when view specific processing is required.

It is possible to use AWS Cognito and its internal Identity Provider (IDP) for user sign-up and sign-in features and use JWT access tokens to authenticate user identity. Application level roles and role-mapping to resources (HTML pages, Micro Services APIs, etc.) are used to implement role-based access control.

This particular implementation provides computationally efficient processing and is particularly advantageous for the implementation of the methods disclosed herein. More particularly, DynamoDB is a NoSQL database, which means that data records are not managed in relational data structures, such as tables where all rows hold the same number of column. Instead, the database uses hashing and B-trees to support key-value and document data structures. This makes the storage and processing of documents, such as the product characterisation, as well as the tree structure of the tariff classification extremely efficient. This leads to short execution times for learning as well as evaluation of the classification methods disclosed herein.

### Classification Pipeline

A further aspect of this disclosure, and contribution to overcoming the problem of computational complexity and processing time, is the provision of a classification pipeline. As the name implies, the pipeline is a sequence of steps that are performed. In each step, the pipeline classifies the product to a finer granularity, represented by a deeper level in the hierarchical classification graph. This is in contrast to multiclass classification described above where each classifier operates in parallel.

It is noteworthy that the classification pipeline is most likely different for each product that is to be classified. That is, the components are connected based on the product characterisation so that the pipeline is specific to the product classification in the sense that a different classification comes from a different pipeline. Each pipeline consists of a number of components, which are selected ‘on-the-fly’ as the product features become available and as the output values of previous components of the pipeline become available. In this case, the pipeline is a dynamically created selection of components to thereby create a chain of components instead of a monolithic classification framework, such as most mathematical classifiers. Each component is independent in its classification in the sense that the classification does not use the output or other parameters of an upstream component. Therefore, each classification component of the pipeline is configured to independently generate digits of the tariff classification additional to the classification output of a classification component upstream in the pipeline. “Upstream” is used herein to earlier applied components that provide the earlier (leftmost) digits of the classification (coarser classification), where “downstream” is used for later applied components that provide later (rightmost) digits of the classification (finer classification).

The dynamic creation of a pipeline of classification components leads to a computationally efficient solution since multi-class classification is not required for a large number of output classes. It is noted here that each classification component may be represented by a piece of software. That is, each classification component may be implemented as a Java class and an instance is created for each product when this component is selected. In other examples, each classification component is implemented as a separate binary that can be executed with its own process ID on a separate virtual machine.

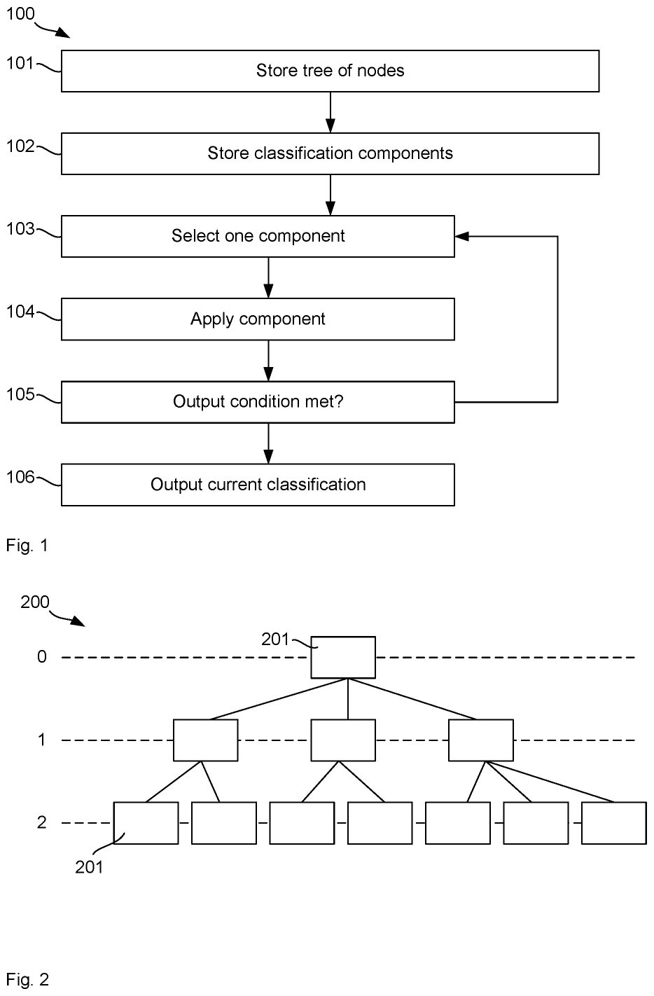

FIG. 1 illustrates a method 100 for classifying a product into a tariff classification. As mentioned above, the tariff classification is represented by a node in a tree of nodes, which can be stored efficiently in NoSQL databases. More particularly, the tree of nodes represents a hierarchical structure of classification.

A product entity holds information about a product that needs to be classified. This information is also referred to as product characterisation. In one sense, this can be considered as a text document, which again, can be stored efficiently in a NoSQL database, especially once the information is semantically and grammatically analysed and tokenised. In other examples, the product characterisation is stored in a database or CSV file as parameter, value pairs. Minimally, it consists of an id and title/name but can include many other attributes including description, bullet-points, material-composition, etc. It can also have attachments associated with it. These attachments can include information such as product documentation, spec sheets, brochures, images, etc. The user can pass all the product information via an API, create manually, or a combination of the two. For simplicity, some of the ad-hoc classification UIs let you get a classification recommendation based on just a product description. Behind the scenes, this information is used to create a simple product entity that is passed to the classification engine.

FIG. 2 illustrates an example tree structure 200 comprising 11 nodes illustrated as rectangles, such as example node 201. The nodes are connected by edges, which are illustrated as solid lines. A ‘tree’ is a graph with no reconverging edges. In other words, a tree is an undirected graph in which any two vertices are connected by exactly one path, or equivalently a connected acyclic undirected graph. It is noted here that tree structure can be stored very efficiently in a NoSQL database as described herein.

Tree 200 has multiple levels as indicated by dashed lines. The levels start at level ‘0’ for the root node 201 and end at level ‘2’ for the leaf nodes, such as example leaf node 202. The leaf nodes represent the classification output. However, most tariff classification trees have more than three levels, which are not shown in FIG. 2 for clarity. In some examples, level 1 is referred to as the ‘section’ and level 2 is referred to as the ‘chapter’. There may be 22 sections (i.e. 22 nodes in level 1) and 99 chapters (i.e. 99 nodes in level 2). Each section, that is, each node in level 1 may be associated with a two-digit identifier (1-22). Similarly, each section, that is, each node in level 2, may also be associated with a two-digit identifier (1-99). As such, the level 1 identifier may also be omitted because the level 2 identifier is already unique. Further layers may be referred to as headings and sub-headings.

For example, level 2 identifier 64 identifies chapter 64 (“footwear, gaiters”), which is a chapter of section 12 (“footwear, headgear, umbrellas, . . . ”). So, each chapter is identified by a two-digit code and sub-classifications can add digits to that two-digit code. For example, code 6402 refers to a further classification to “Other footwear with outer soles and uppers of rubber or plastics” which can again be further classified.

The tree of nodes 200 may be stored in a graph database for efficient access by a computer processor, which will be described further below. Returning to FIG. 1, the processor stores 101 the tree of nodes. In addition to what is shown in FIG. 2, each node is associated with a text string. That text string is indicative of a semantic description of that node as a sub-class of a parent of that node. The text strings are publicly available for the tariff classification at the U.S. International Trade Commission (https://hts.usitc.gov/). Each text string is a brief description of products that fall under this classification. It is noted that the text strings may not be a global classification and may not be globally unique across the entire tree. Instead, they may only further specify the previous node. For example, the text string ‘plates’ may exist under chapter 69 “ceramic products”, chapter 70 “glass and glassware”, chapter 73 “articles of iron and steel”, etc.

In one example, tree 200 represents the Harmonized Commodity Description and Coding System, also known as the Harmonized System (HS) of tariff nomenclature, which is an internationally standardized system of names and numbers to classify traded products. The HS is organized logically by economic activity or component material. For example, animals and animal products are found in one section of the HS, while machinery and mechanical appliances are found in another. The HS is organized into 21 sections, which are subdivided into 99 chapters. The 99 HS chapters are further subdivided into 1,244 headings and 5224 subheadings. Section and Chapter titles describe broad categories of goods, while headings and subheadings describe products in more detail. Generally, HS sections and chapters are arranged in order of a product's degree of manufacture or in terms of its technological complexity. Natural commodities, such as live animals and vegetables, for example, are described in the early sections of the HS, whereas more evolved goods such as machinery and precision instruments are described in later sections. Chapters within the individual sections are also usually organized in order of complexity or degree of manufacture. For example, within Section X (Pulp of wood or of other fibrous cellulosic material; Recovered (waste and scrap) paper or paperboard; Paper and paperboard and articles thereof), Chapter 47 provides for pulp of wood or of other fibrous cellulosic materials, whereas Chapter 49 covers printed books, newspapers, and other printed matter. Finally, the headings within individual Chapters follow a similar order. For example, the first heading in Chapter 50 (Silk) provides for silk worm cocoons while articles made of silk are covered by the chapter's later headings.

The HS code consists of 6-digits. The first two digits designate the HS Chapter. The second two digits designate the HS heading. The third two digits designate the HS subheading. HS code 1006.30, for example indicates Chapter 10 (Cereals), Heading 06 (Rice), and Subheading 30 (Semi-milled or wholly milled rice, whether or not polished or glazed). Many parties sub-divide further into 8- or 10-digit codes. Although every product and every part of every product is classifiable in the HS, very few are explicitly described in the HS nomenclature. Any product for which there is no explicit description can be classified under a “residual” or “basket” heading or subheading, which provide for Other goods. Residual codes normally occur last in numerical order under their related headings and subheadings.

While it may appear possible to use existing classification algorithms for the specific problem of tariff classification, it does become apparent that the actual implementation will become impractical due to limitations of existing computing hardware. Further, existing classification algorithms are inaccurate because of the textual character of the classification task. As a result, well-known computer functions are not sufficient to practically implement a tariff classifier on existing computers.

The processor further stores 102 multiple classification components. Classification components are pieces of software that perform a part of the overall classification. In that sense, each classification component operates on a particular location or over a particular area of the classification tree, also referred to as a sub-tree. In some examples, each classification component operates on a single node and makes a decision to select one of the child nodes of that node as a classification output. In that sense, each classification component has product features as input and a classification into one of the nodes as an output. For example, there may be one classification component for each of the 99 chapters of the HS tree. Other classification components may exist for a specific heading or sub-heading. A component may comprise filter-criteria, a set of important product features, tariff annotations, or ML models. Due to the limited ‘scope’ within the tree of each component, the processor can train and evaluate each component relatively quickly, which enables tariff classification with many possible classes.

The processor iteratively selects at 103 one of the multiple classification components based on a current classification of the product. Selecting of a component may also be referred to as component resolution. Then, the processor applies 104 the selected multiple classification component to the product features to update the current classification of the product. In other words, the processor evaluates the trained model in the component for the input of the particular product. Responsive to meeting a termination condition 105, processor outputs 106 the current classification as a final classification of the product.

### Classification Component Resolution

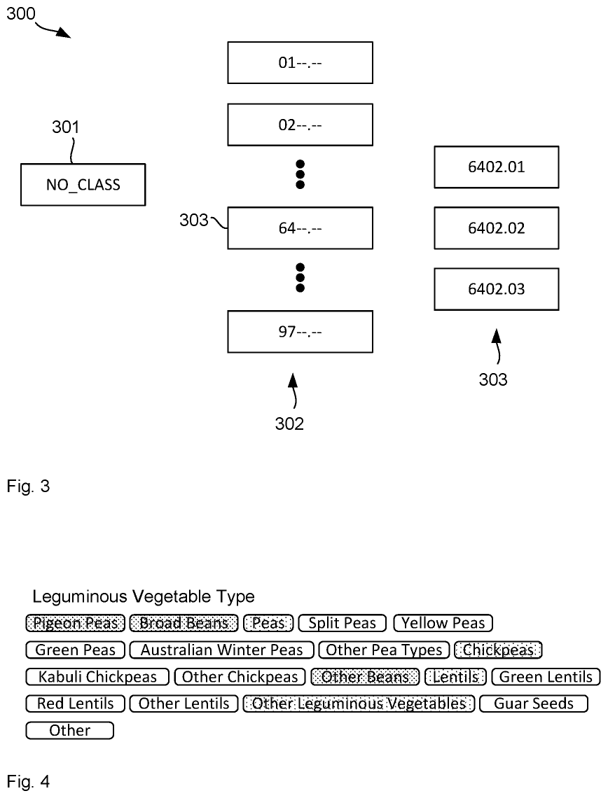

FIG. 3 illustrates a set of components 300 as stored by the processor. The set 300 is arranged graphically for illustration but in data memory, the components may be stored in any order. In particular, the components may not have any references to each other in order to represent a graph or tree structure. Instead, the components may be stored independently without relationships between them.

Each component in FIG. 3 is shown with a filter-criteria. The filter-criteria for a component consists of a HS code filter that must be satisfied for this component to be suitable for the product in question. Further, the processor may select one of the components based on determining the presence of keywords in the product characterisation. Therefore, there may be match and elimination keyword filters. A product starts without any classification-code (represented by the constant NO_CLASS) and is classified as it flows through one or more components. A first component 301 is designed to pick up products without any classification, in which case the HS filter should specify NO_CLASS. That is, this classification component is applicable only if the product is unclassified. As further explained below, the components applicable to the unclassified products, classify the product into one of the 97 chapters of the tariff classification. Other components process products that have a partial classification. That is, those components are applicable only if the product is partly classified. For example, there may be 97 country-agnostic chapter-components 302 that take products without a current classification and assign a six-digit classification.

Another set of country-specific components will pick up products after they've been assigned a six-digit HS code and refine the classification to a dutiable HS code, typically being 10-digits. For example, there may be defined a country-agnostic component called CH64 303 for chapter-64 (footwear) that will predict and assign a six-digit sub-heading under chapter-64. We can also define a US specific component called CH64_US that will expand the classification to a 10-digit HS code. In this example, CH64 303 is configured with a HS code filter of “64” and CH64_US would be configured with a HS code filter of “64--.--”. Notice the “-” character in the HS code filter for CH64_US. It is a wild-card that matches any character. Therefore, this filter would match any six-digit HS classification code that belongs to chapter 64. FIG. 3 illustrates a further sub-set of components 303 that are configured to classify products with an assigned 6-digit code into 10-digit classes.

The NO_CLASS component 301 is used initially to determine the correct chapter (2-digit HS code) using a ML model along with a few feature annotations. The NO_CLASS component may comprise a Support Vector Machine (SVM), Nearest Neighbor, FastText, or Multi-Layer Perceptron (MLP). In the example of an SVM, given a set of training examples, each marked as belonging to one the chapters, an SVM training algorithm builds a model that assigns new examples to one chapter, making it a non-probabilistic linear classifier. An SVM maps training examples to points in space so as to maximise the width of the gap between the output classifications. New examples are then mapped into that same space and predicted to belong to a classification based on which side of the gap they fall. In one example, a binary SVM is used that is extended to this multiclass problem using one-versus-all or one-versus-one approaches. This results in about 4,600 different classifiers for 97 output classifications. This is an amount that is much more manageable than the 180 million classifiers required for other methods as explained above. So only 0.0026% of the original computational complexity is required at this level, which is a significant reduction. It is noted that further layers will required further classifiers but the number of output classes is less 100 in almost all cases, so overall, the number of required classifiers will stay relatively low.

The processor is given a training dataset of n points of the form

$$( {x}_{1} , {y}_{1} ) , … , ( {x}_{n} , {y}_{n} ) ,$$

where the y, are either 1 or −1, each indicating the class to which the point x; belongs. Each xᵢ is a p-dimensional real vector. The processor finds the “maximum-margin hyperplane” that divides the group of points xᵢ for which yᵢ=1 rom the group of points for which yᵢ=−1, which is defined so that the distance between the hyperplane and the nearest point x; from either group is maximized.

Any hyperplane can be written as the set of points x satisfying

$${w}^{T} x - b = 0 ,$$

where w is the (not necessarily normalized) normal vector to the hyperplane.

The parameter b/∥w∥ determines the offset of the hyperplane from the origin along the normal vector w. If the training data is linearly separable, the processor can select two parallel hyperplanes that separate the two classes of data, so that the distance between them is as large as possible. The region bounded by these two hyperplanes is called the “margin”, and the maximum-margin hyperplane is the hyperplane that lies halfway between them. With a normalized or standardized dataset, these hyperplanes can be described by the equations

w^{T}x−b=1 (anything on or above this boundary is of one class, with label 1)

and

w^{T}x−b=−1 (anything on or below this boundary is of the other class, with label −1).

Geometrically, the distance between these two hyperplanes is 2/∥w∥ so to maximize the distance between the planes the processor to minimizes ∥w∥. The distance is computed using the distance from a point to a plane equation. The processor may also have to prevent data points from falling into the margin, which is achieved by the following constraint: for each i either w^{T}xᵢ−b≥1 if yᵢ=1, or w^{T}xᵢ−b≤−1, if yᵢ=−1.

These constraints state that each data point must lie on the correct side of the margin. This can be rewritten as

$${y}_{i} ( {w}^{T} {x}_{i} - b ) \geq 1 ,$$

for all 1≤i≤n.

We can put this together to get the optimization problem: “Minimize ∥w∥ subject to yᵢ(w^{T}xᵢ−b)≥1 for i=1, . . . , n.”

The w and b that solve this problem determine the classifier, x [symbol] sgn(w^{T}x −b) where sgn(⋅) is the sign function. In other examples, a soft-margin may be used, such as by minimising:

$$[ \frac{1}{n} {\sum }_{i = 1}^{n} max ( 0 , 1 - {y}_{i} ( {w}^{T} {x}_{i} - b ) ) ] + λ {‖ w ‖}^{2} . .$$

An important consequence of this geometric description is that the max-margin hyperplane is completely determined by those i, that lie nearest to it. These xᵢ are called support vectors.

The chapter classification generated by the NO_CLASS component is then used to route the product to one of the 97 country-agnostic chapter components 302. The 97 chapter components 302 may comprise respective class models with stratified training data consisting of 3M products from handled customs filings. The product descriptions in this training set are quite short (an average of 4.5 words) and it may be beneficial to eventually train this model using products with more robust descriptions.

Each classification component can also be configured with match and elimination keywords that may further aid in the resolution of the most appropriate classification component for a classification request. In other words, the processor matches the keywords against the product characterisation and selects the component with best match (positive or negative).

Each product description in the training data is converted into a vector representation using either Word2Vec (or FastText) embeddings. Word2vec contains word-embeddings for each word that captures the context in which that word appeared across a very large corpus of training data.

A word vector can be used to determine similarity in semantic meaning between strings, even though the strings themselves are different. For example, ‘cat’ and ‘pet’ are dissimilar strings. Yet, they have very high cosine similarity in the model's vector space. Conversely, ‘tea bags’ and ‘tea towels’ are string similar but semantically different. The word vector therefore can learn relationships and similarities between words that occur in similar contexts in the sources that are provided to it. The word vector approach contrasts with using string similarity metrics like Levenshtein distance, which can be used but may end up with a less accurate result.

A generic word vector (such as word2vec) can be trained on articles from generic external sources (such as for example Google News) to provide results at a statistically high accuracy for many applications. To improve results further for tariff classification, a specific tariff classifier word vector model can be trained on articles from external sources relevant to tariff classification such as the HS, tariff documentation, product websites, online retailers or other similar documents to learn relationships and similarities between words that occur in similar contexts for the purpose of tariff classification.

fastText is a library for text classification and representation available from fasttext.cc. It transforms text into continuous vectors that can later be used on any language related task. fastText uses a hashtable for either word or character ngrams. The size of the hashtable directly impacts the size of a model. To reduce the size of the model, it is possible to reduce the size of this table with the option ‘-hash’. For example a good value is 20000.

Another option that greatly impacts the size of a model is the size of the vectors (-dim). This dimension can be reduced to save space but this can significantly impact performance. If that still produces a model that is too big, one can further reduce the size of a trained model with the quantization option. One of the key features of fastText word representation is its ability to produce vectors for any words, even made-up ones. Indeed, fastText word vectors are built from vectors of substrings of characters contained in it. This allows to build vectors even for misspelled words or concatenation of words. fastText based on the skipgram model, where each word is represented as a bag of character n-grams. A vector representation is associated to each character n-gram; words being represented as the sum of these representations. The method is fast, allowing to train models on large corpora quickly and enables to compute word representations for words that did not appear in the training data.

Given a word vocabulary of size W, where a word is identified by its index w∈{1, . . . , W}, the goal is to learn a vectorial representation for each word w. Word representations are trained to predict well words that appear in its context. More formally, given a large training corpus represented as a sequence of words w₁, . . . , w_{T}, the objective of the skipgram model is to maximize the following log-likelihood:

$${\sum }_{t = 1}^{T} {\sum }_{c ∈ {C}_{t}} log p ( {w}_{c} \vert {w}_{t} ) ;$$

where the context Ct is the set of indices of words surrounding word wt. The probability of observing a context word w_{c} given wₜ will be parameterized using the aforementioned word vectors. For now, let us consider that we are given a scoring function s which maps pairs of (word, context) to scores in [symbol] . One possible choice to define the probability of a context word is the softmax:

$$p ( {w}_{c} \vert {w}_{t} ) = \frac{{e}^{s ( {w}_{t} , {w}_{c} )}}{{\sum }_{j = 1}^{W} {e}^{s ( {w}_{t} , j )}} .$$

The problem of predicting context words can be framed as a set of independent binary classification tasks. Then the goal is to independently predict the presence (or absence) of context words. For the word at position t the processor considers all context words as positive examples and sample negatives at random from the dictionary. For a chosen context position c, using the binary logistic loss, the processor obtains the following negative log-likelihood:

$$log ( 1 + {e}^{- s ( {w}_{t} , {w}_{c} )} ) + {\sum }_{n ∈ {N}_{t , c}} log ( 1 + {e}^{s ( {w}_{t} , n )} ) ;$$

where N_{t,c} is a set of negative examples sampled from the vocabulary. By denoting the logistic loss function l:x [symbol] log(1+e^{-x}), we can re-write the objective as:

$${\sum }_{t = 1}^{T} [ {\sum }_{c ∈ {C}_{t}} l ( s ( {w}_{t} , {w}_{c} ) ) + {\sum }_{n ∈ {N}_{t , c}} l ( - s ( {w}_{t} , n ) ) ] ,$$

A natural parameterization for the scoring function s between a word w_{c} and a context word w_{c} is to use word vectors. Let us define for each word w in the vocabulary two vectors u_{w} and v_{w} in [symbol] ^{d}. These two vectors are referred to as input and output vectors. In particular, we have vectors u_{wt} and v_{wc}, corresponding, respectively, to words wₜ and w_{c}. Then the score can be computed as the scalar product between word and context vectors as s(wₜ, w_{c})=u_{wt}^{T}v_{wc} The model is the skipgram model with negative sampling.

Word embedding, in natural language processing (NLP), is a representation of the meaning of words. It can be obtained using a set of language modelling and feature learning techniques where words or phrases from the vocabulary are mapped to vectors of real numbers. Conceptually it involves a mathematical embedding from a space with many dimensions per word to a continuous vector space with a much lower dimension. Methods to generate this mapping include neural networks, dimensionality reduction on the word co-occurrence matrix, probabilistic models, explainable knowledge base method, and explicit representation in terms of the context in which words appear. Word and phrase embeddings, when used as the underlying input representation, have been shown to boost the performance in NLP tasks such as syntactic parsing and sentiment analysis.

The contextual semantics captured by the word embeddings enable the processor to perform mathematical operations including similarity calculations. This enables to determine that “netbook” is semantically similar to “Chromebook”, “Ultrabook”, “laptop”, “ultra-portable”, etc. This is powerful in that the user does not have to enumerate all possible product examples but rather a stratified subset that covers the variety of products that can be classified by the component.

So returning to FIG. 1, the processor selects one component in FIG. 3 by iterating over all components and applying the filter criteria of the current component to the product features, including the current classification code. If the filter criteria match, the processor uses the matching component. If they do not match, the processor moves on to the next component until the processor finds a matching component. Once a matching component is found in step 103, the processor applies that component. This may include applying a machine learning model or other mathematical, logical or algorithmical operation to the product features.

It is noted here that components 302 and 303 do not need to distinguish their classification from that of other components. In other words, the classification has already progressed through the tree and the components do not need to go back to the root tree. For example, if CH64 component 303 encounters the word “sole”, there is no need to consider the disambiguation between the fish species of “sole” and a shoe sole. The product has already been classified as footwear, so CH64 can be trained with significantly lower computational effort.

It is noted again, that the tree structure of the actual classification problem is not replicated in the set of classification components 300. As a result, at each classification step while traversing the tree, the processor searches in the entire collection of components for a matching component. While, at first glance, this may appear as an overhead, there are surprising advantages associated with this construction. First, the searching for a matching component can be implemented very efficiently when using database engines, which have highly optimised search and filter operations, potentially using hash tables and indexed searching. Further, each classification task can be easily executed by a separate processor or virtual machine, which enables scaling to a large scale. Importantly, however, each component can be trained individually and very efficiently with a small number of training samples or even without training samples where the text strings associated with the corresponding node are sufficient for classification. Therefore, the proposed architecture has computational advantages that are not achieved by other structures, such as tree-structures where classification components are arranged in a similar structure to the classification tree.

### Extending Components

Component extension is specifically supported to allow a World Customs Organisation (WCO) component to be used as a starting point for country-specific components. For example, WCO components can defined for each chapter that take the classification from 2-digits to 6-digits. This is followed by a country specific extension to each of those components. The reason for extending a WCO component instead of defining a new component is that often times the features and categories defined in the WCO component can be used in annotating the country specific portions (if this is not required it is also possible to create a new component instead of extending a base component). The solutions disclosed herein provide a modular approach using classification components, which has the advantage that components can be re-configured, replaced or added. Further, components can be trained without training other components. This is in contrast to existing decision models where the entire model needs to be re-trained if a single node changes slightly. Therefore, computational burden on existing model becomes prohibitive in the area of tariff classification. In contrast, the disclosed solution enables the local training of local classifiers which reduces the computational burden by magnitudes compared to full-model retraining.

The component that is being extended is referred to as the base-component and the new component being created is referred to as the refined-component. The features, categories, and keyword-lists from the base-component are inherited by the refined-component and anytime the base-component is updated, the refined components will “see” those changes. A user can manually “sync” a refined-component by clicking the “Sync” button in a component details page of a user interface. The inherited features, categories, and keyword-lists can NOT be modified in one example. However, a user can create additional features as needed for annotating portions of the tariff that are not covered by the inherited features. The user can also refine an inherited category into sub-categories. When refining an inherited category, the user defines the new constituent categories and specifies the base category that is being refined. When the product classification transitions from the base-component to the refined component, any feature that is assigned a category that is refined by the base-component, that category is converted to one or more of the sub-categories, depending on whether the processor is able to reduce the sub-categories via a ML-Model or keyword matching.

The use of base-components and refined-components reduces the storage requirements in a practical computer implementation. Further, the overall computational burden is reduced because the information does only need to be extracted for the base-component and not again for the refined-component.

The processor may provide an annotation-editor UI. When defining/editing a refined component, inherited features and categories are displayed in a red-like color to distinguish them. Inherited categories that are refined are displayed in a faded-red color and are immediately followed by the refined sub-categories. FIG. 4 shows an example from Chapter 07, where red categories are shown as dark shaded and faded-red categories are shown as lightly shaded. The initial set of categories for the inherited feature “Leguminous Vegetable Type” is “Pigeon Peas”, “Broad Beans”, “Peas”, “Chickpeas”, “Other Beans”, “Lentils”, and “Other Leguminous Vegetables”. The refined component has refined the “Peas” category into “Split Peas”, “Yellow Peas”, “Green Peas”, “Austrian Winter Peas”, and “Other Pea Types” sub-categories. Base categories “Lentils” and “Other Leguminous Vegetables” have been refined as well.

As shown in FIG. 4, the categories are displayed as a sequence from left to right with line breaks. Where a category is refined, the refined features are shown immediately after the broader category in the sequence. This way, a user can easily see which category refine which super-category. So in FIG. 4, a user can easily see that “Split Peas” refines “Peas” because “Split Peas” is immediately after “Peas” and with a different shade.

This is a powerful concept and removes the need to create a large number of redundant features when the granularity of categories defined in the base-component is not sufficient to annotate the country specific portion. In other words, the classification can be re-configured to be more granular for select classification outputs. For example, the classification output “Peas” can be configured to be more granular without affecting the “Peas” feature inherited from the original component.

### Classification and Feature Extraction

As described above with reference to FIG. 1, at step 104, the processor applies a classification component to the product information to determine an output classification. The following disclosure provides further detail on how to implement this classification efficiently.

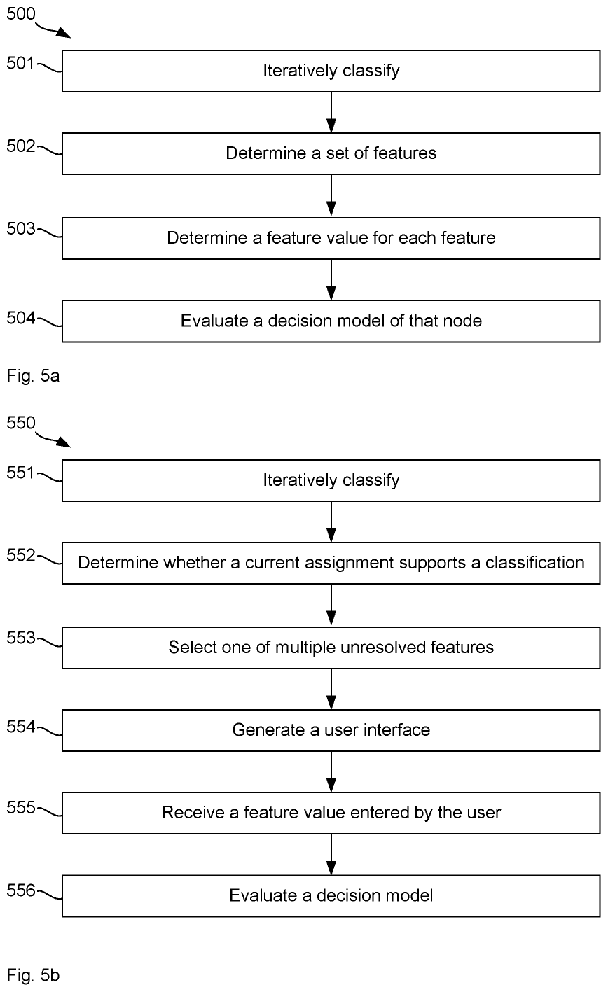

In particular FIG. 5a illustrates a method 500 for classifying a product into a tariff classification, such as the HS tariff nomenclature. As set out above, the tariff classification is represented by a node in a tree of nodes as shown schematically in FIG. 2 but with a large number of nodes. Each node is associated with a text string indicative of a semantic description of that node as a sub-class of a parent of that node. The text strings are also available at the U.S. International Trade Commission (https://hts.usitc.gov/) as part of the tariff nomenclature.

As also set out above, the processor essentially traverses 501 the tree of nodes along a path through the tree of nodes. In this way, the processor classifies, at the nodes on the path, the object product into one of multiple child nodes of that node. It is noted that the ‘path’ may not be implemented explicitly, because the processor may select one of multiple classification components at each point. This way, the path will consist of the selected classification components, but the path itself may not be stored, since it is not necessary to re-trace the path. Again, this leads to a reduction in storage requirements and computational complexity since a large number of potential paths would be possible.

It is further not necessary that the processor performs classification at every node on the path, since the processor may ‘jump’ nodes by classifying more granularly than the immediate child nodes. For example, CH64 (303 in FIG. 3) may classify the product into one of multiple sub-headings (6-digit codes) which is more granular than headings. In that sense, the processor ‘jumps’ over the headings node and proceeds directly to the sub-headings. Again, this makes the classification process computationally more efficient because components are not needed for every possible node.

Classifying the product at each stage may comprise a three step process, comprising determining features 502, determining feature values 503 and evaluating a decision model 504. It is noted here that a feature of a product is a particular parameter or variable, which is referenced by a parameter/variable name or index. So by determining a set of features, the processor essentially selects features from the available features for use in the classification. The selected features may be independent from the specific product to be classified. That is, the selected features may remain the same for a large number of completely different products. For each of these different products, each feature is associated with a feature value although some features may have an empty or Nil value if that feature cannot be determined for that product. That is, most feature values will be different for different products, while the features themselves remain the same.

So in step 502, the processor determines a set of features of the product. In making this determination, the processor selects those features that are discriminative for that node. Discriminative features are those features that enable the processor to discriminate between different child nodes, i.e. output classes of that classification component. The processor selects these features by extracting the features from the text string indicative of a semantic description of that node. It is noted that this semantic description is not part of the product description but part of the classification tree. Therefore, the semantic description of a particular node remains the same for multiple different products to be classified. However, it is noted that this particular node may not be visited during the classification of both product if they are classified into different chapters at the beginning of the process.

The process of feature selection significantly reduces computational burden because the required processing power increases more than linearly with the number of features for training as well as evaluation.

Once the features are selected for classification, the processor turns to the product data. More particularly, the processor determines 503 a feature value for each feature of the product by extracting the feature value from object product data. Again, it is noted that the processor first determines features from the description of the tariff node, and then extracts the feature values from the product description.

Finally, the processor evaluates 504 a decision model of the current node for the feature values that the processor extracted from the product description. The decision model is defined in terms of the extracted feature for that node from the semantic description/text string of that node.

The determined features can also be referred to as “important product characteristics” as outlined by the portion of the tariff that the component operates on. The definition of each product feature is accompanied by the distinct set of categorical values that can be assigned to that feature. These categorical values provide an exhaustive list of allowed values for a particular feature. For example, this could by “male”/“female”.

In one example, every product passed to a given component has a subset of these product features defined. The processor can extract these features for a product using either machine learning (ML) or natural language processing (NLP). To use ML, the processor first trains a feature-model by feeding it training data, each of which is labelled with one of the categorical values. In other words, the processor performs supervised training where the training samples are products with respective descriptions. The ML output (i.e. ‘label’) is one of the categorical values. For the training set, these categorical values are provided to the processor, so that the processor can train an ML model that can then predict categorical values for previously unseen product descriptions. If such training data exists in sufficient quantity, a predictive ML model will likely be superior to NLP techniques since its underlying model will capture relationships and information that is difficult to encode using NLP.

In other examples, it may be easier, for example, to determine gender of a clothing article by looking for keywords such as: man, men, woman, women, girl, boy, etc. One issue with training a ML model is the availability of sufficient stratified training data. The feature-model discussed here is different than models trained to directly predict product classifications since the feature-models are trained to only predict the correct category for a given feature and not the output classification.

As set out above, there is generally a problem with training ML classifiers in that many training samples are typically required for an acceptable accuracy, leading to long computation times. Importantly, the disclosed ML method for feature value extraction is significantly less complex computationally than training the classifier itself. This is because the trained model can be re-used across the entire set of classification components, which means the model needs to be trained only once, rather than training each classification component individually. So the described three step process of selecting features, extracting feature values for the product and then deciding on the classification based on those feature values, significantly reduces processing time and/or increases accuracy dramatically for a given processing time.

### Feature Extraction Using Keywords

Often these features are described in the title, description, or some other unstructured text attribute of a product and can be extracted using NLP techniques to match keywords associated with each categorical value. This is a viable alternative in the absence of training data and can be quite effective, especially when the keywords associated with each category is extensive (see below).

FIG. 5b illustrates a method 550 for classifying a product into a tariff classification. Again, the tariff classification is represented by a node in a tree of nodes and each node is associated with a text string indicative of a semantic description of that node as a sub-class of a parent of that node. The method is performed by the processor, and so, the processor iteratively classifies 551, at one of the nodes of the tree, the product into one of multiple child nodes of that node. The classifying comprises the following steps.

First, the processor determines 552 whether a current assignment of feature values to features supports a classification from that node. Then, upon determining that the current assignment of feature values to features does not support the classification from that node, the processor selects 553 one of multiple unresolved features that results in a maximum support for downstream classification and generates 554 a user interface comprising a user input element for a user to enter a value for the selected one of the multiple non-valued features.

In response to the user entering or selecting feature values, the processor receives 555 a feature value entered by the user and then evaluates 556 a decision model of that node for the received feature value. The decisiona model is defined in terms of the extracted feature for that node and may be a decision tree, for example.

As set out above, the classification accuracy degrades significantly in cases where feature values are missing from the input data. Existing methods would simply output a classification result that is incorrect. The method proposed above can detect missing feature values and provide accurate values by way of user input. As a result, the accuracy of the output classification is significantly improved. It is further noted that another approach could be to present a form to the user to enter all relevant feature values. However, the user would be easily overwhelmed and it would be inconvenient and error prone to enter all the required information. The method disclosed herein only requests user input where the feature value cannot be determined automatically. Thereby, user effort in entering data is significantly reduced, making the resulting classification method significantly more practical.

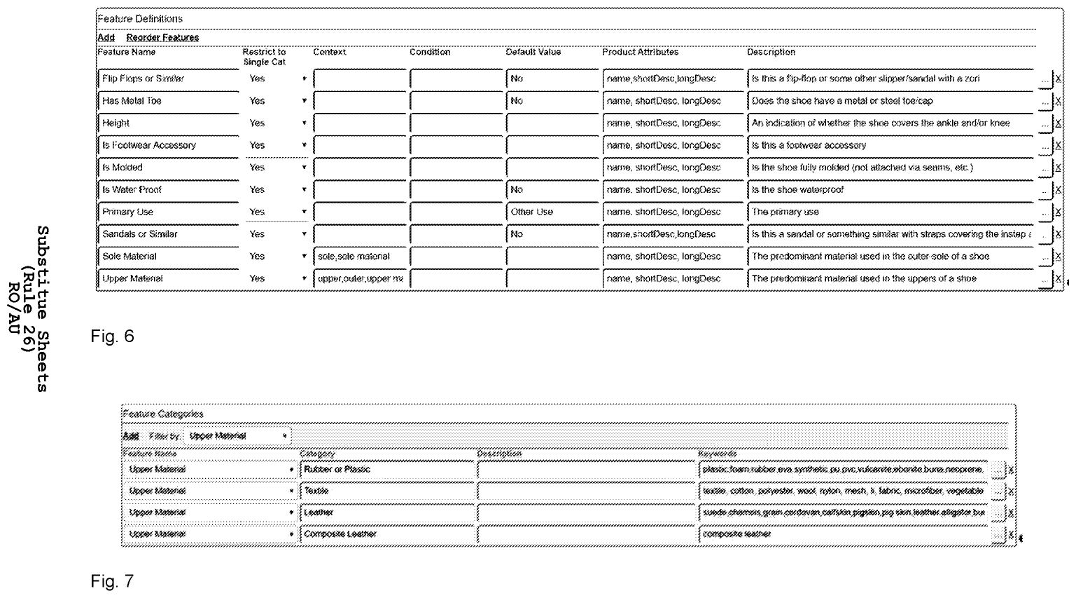

FIG. 6 is a screen shot of the set of categories that have been defined for the Chapter 64 (Shoes) component. Once determined, these features can be used to build tariff traversal rules (i.e. decision models), guardrails for ML predictions, and be fed in as categorical features when training ML models to predict classification codes. Given a very large, stratified set of training data, ML models are able to learn the importance of these feature characteristics on their own. However, feeding a model a set of categorical features that have causality on the classification greatly improves the predictability of a model.

The categorical values configured for the upper_material feature is shown in FIG. 7 along with the set of keywords associated with each of these categorical values.

### Feature Types

There are several types of features that are supported by the System. Features can be categorical, numeric-range, and action. Categorical features are the most prevalent and assign a categorical value to the feature based on invoking a ML model or finding keywords.

### Action Feature

An action-feature is useful in presenting a classifier with alternatives when some condition is met. An example of an action-feature is used in the WCO Chapter 07 component. Chapter 07 is reserved for “Edible vegetables and certain roots and tubers” and the processor can let the classifier know that if the commodity that is being classified is a preparation of vegetables, it should be classified into Chapter 20. We use an action-feature to accomplish this and consists of the following.
Feature Description—The feature description is what is displayed as a note to the user when the condition is satisfied.
Feature Condition—The note is displayed to the user after a condition has been met if and only if the category has been identified. The condition can be in the form of either 1) HS_CODE=<comma-separated HS list>, or 2) <Feature>=<comma-separated category list>.
Category Name—The category-name is composed of two parts, separated by a colon. The first part is the display value and the second part is the HS that the user will be navigated to if they click on this action. The display-value and category description is not currently used.
Category Keywords—The category keywords determine if this action is presented to the user if and when the feature-condition has been met.

### Numerical-Range Feature

A numeric-range feature is used to find a numeric value in unstructured text, normalize its stated unit to a base unit, and select the appropriate categorical value based on the configured range for each category. A numeric-range feature consists of the following.
Numeric Type—The type of numeric value that is to be searched for. The value will be searched in the attributes specified for this feature.
Extraction Category—A special category with the name “Extraction” is used to extract the value. The context of this category is automatically set to the numeric-value and it can be configured with keywords like any other category. For example, processor extracts the percentage of man-made fibers in an article of clothing. A numerical-range feature can be configured with a numeric-type of percentage. The “Extraction” category may be configured with all keywords that represent man-made fibers. This causes the System to look for a numerical-percentage value preceded or followed by one of the configured keywords (e.g. 25% rayon, 33% nylon, 50% acrylic). If multiple keywords are found, the numeric value will be aggregated.
Range Categories—All other categories of a numeric-range feature may be configured with the $range macro. The range macro takes a four-part colon-separated parameter that specifies a numeric range in the base unit for the numeric-type. The four parts are composed of lower-bound, lower-bound inclusivity flag, upper-bound, and upper-bound inclusivity flag. The inclusivity flags are by default false. If there is no lower-bound or upper-bound, it can be left blank. Here are a few examples . . .
   $range[5]—translates to “>5”
   $range[::10]—translates to “<10”
   $range[5:Y]—translates to “>=5”
   $range[5::10]—translates to “>5 and <10”
   $range[5:Y: 10:Y]—translates to “>=5 and <=10”

### Keyword Management

Providing a robust set of keywords increases the probability that the System will automatically be able to determine a feature value instead of having to solicit the user. To aid in this process, there is provided a comprehensive keywords assistance module that integrates with WordNet and Word2Vec to obtain synonyms, hyponyms, sister-terms (related words), and contextual words. The former three are obtained from WordNet (a lexical database of semantic relations between words) and the last from Word2Vec (described earlier). There are also added several useful features, including keyword-lists and macros that we will describe in this section.

### Cosine Similarity

As mentioned above, providing a robust set of keywords helps the System automatically determine feature values instead of soliciting the user. However, there is the possibility that the product description uses unconfigured keyword(s). To help in such scenarios, the System can use cosine-similarity to determine which category(s) appear to be “closest” to the product description. The processor converts unstructured text to a numeric vector representation to perform operations on them. A cosine-similarity is the measure of how close the two vectors are to each-other.

The processor creates a vector for the product and a vector for each category using the configured set of keywords. The processor then computes a cosine-similarity and returns the categories with the highest similarity and present to the user. If this operations leads to one category that is a much better match than others, the processor can use that category as the value for the feature and continue without any user intervention. At the very least, this computation reduces the set of viable categories that are presented to the user. Further, the processor may first reduce the set of words to only those that are relevant.

Configuring Compound Keywords, Exclusion Keywords, and Multiple sets of Keywords

Keywords can consist of up to four words that are looked for in the specified set of product attributes. These keywords are looked for after lemmatization (the process of reducing inflection in words to their root forms). Further, multi-word keywords (phrases) are searched for in the text both before and after removing stop-words (the most common words such as “the”, “and”, “is”, “of”, etc.). Finally, bi-words in the form “w1 w2” match both “w1 w2” and “w2 w1”.

The list of keywords associated with a category are comma separated and the category is assigned to the feature if one or more keywords are found. The user can also configure the category with one or more exclusion keywords. Exclusion keywords are specified by prepending a “!” to the keyword (for example specifying “!added sugar” eliminates this category as a value for the feature if “added sugar” is found, regardless of how many inclusion keywords are found). The user specifies multiple comma-separate lists of keywords by separating with a semi-colon in which case at least one inclusion keyword from each semi-colon separated list must be found to satisfy the category. Formally, the keyword configuration of “a, b; c, d, !e, !f” would be evaluated as “(a or b) and ((c or d) and not(e or f))”

### Strong Keywords

Prepending an inclusion keyword with a “#” indicates a strong match if that keyword is found. A strong match eliminates other categories that were matched with just regular keywords. This provides an ability to designate certain keywords as unambiguously identifying a specific category. For example, the processor can use the keywords “sweater, pullover, cardigan, slipover, turtleneck, jumper, turtle, polo-neck” to identify the category “Sweaters” for the “Clothing Type” feature. All of the keywords indicate that a garment may be a sweater but only the “sweater” keyword should be designated as strong since its unambiguous. The processor should then configure the keywords as “#sweater, pullover, cardigan, slipover, turtleneck, jumper, turtle, polo-neck”. Strong keywords may be used sparingly and only when a keyword is a very strong indication that this category is correct for its feature.

### Named Keyword Lists

Often it is necessary to configure the same list of keywords for multiple categories.

This poses a maintenance challenge as anytime you need to update the list, you have to remember to do so across multiple categories. Keyword-lists provide a convenient way of creating a named-list of keywords that can be centrally maintained and referenced by multiple categories. For example, the user can create a keyword-list called “Fruits” and configure it with the hundreds of keywords consisting of the various type of fruits. The user can then reference this list for some category by specifying the list-name, prepended by a “$” (e.g. “$Fruits”). When the user updates the keywords of the “Fruits” keyword-list, the categories that reference that list are automatically updated to reflect the changes. The keywords for a category can contain references to multiple keyword-lists, regular keywords, and other macros. For example, the keyword configuration of “$Fruits, a, b, c” would match if the text contains any keywords in the “Fruit” list or the keywords a, b, or c.

Keywords-lists can be created within a component (local keyword-lists) or outside of the component (global keyword-lists). The decision of whether to define a keyword-list as local or global depends on whether the list is applicable across multiple components. If it is, making it global may make sense to remove the duplication of specifying and maintaining the same set of keywords across multiple components. The keyword assistance described below can be used for configuring keywords directly for a category or for keyword-lists.

### Macros

Named keyword-lists are referenced by a category using a macro (e.g. $<list-name>). The System supports several other macros which are defined below, some have mandatory or optional parameters. Macros can be specified with a category and combined with keyword-lists, regular keywords, and macros.
$autoMatch—This macro always evaluates to true and is useful in specifying that a category is identified by default. Unlike the default-category for a feature, a category identified in this manner remains even if another category is identified. The default-category, however, is only assigned to a feature if no other categories are identified. A really good use case for this macro is when it is used in conjunction with a set of exclusion keywords. For example, a category with a keyword configuration of “$autoMatch, !a, !b, !c” would be identified if the text does not contain the keywords a, b, or c. If the keyword configuration were configured as “!a, !b, !c”, it would never match.
$matchOnMultiCats—This macro evaluates to true if multiple (more than one) categories are identified for this feature. Suppose we had a feature named “Dried Fruits” with the categorical values of “Apple”, “Mango”, “Apricot”, and “Mixed Fruits”. We would associate appropriate keywords for the “Apple”, “Mango” and “Apricot” categories but how would we configure the “Mixed Fruits” category. We would want the “Mixed Fruits” category to be identified if we see the word “mixed fruit” but also if we see more than one type of fruit mentioned. We can use this macro and configure the “Mixed Fruits” category with the keywords “mixed fruit, $matchOnMultiCats” to accomplish this.
“$excludeOnAnyCats[<category>]—This macro can be used to eliminate a matched category if any other categories for this feature are identified. If the optional category parameter is specified, this category is eliminated only if the specified category is identified. The macro provides a good way to deal with the catch-all “Other . . . ” categories. For example, if we use our “Dried Fruits” feature example and define categories of “Apple”, “Mango”, “Apricot”, “Citrus Fruits”, and “Other Types of Dried Fruits”. We could take advantage of this macro and configure the “Other Types of Dried Fruits” with the keywords “$Fruits, $excludeOnAnyCats”. This category is initially identified when any type of fruit is mentioned because of the “$Fruits” keyword-list, but, is then eliminated if another category for this feature is identified. For example, if the product description is “bag of dried apples”, both the “Apple” and “Other Types of Dried Fruits” would be identified but the later would be eliminated because of the inclusion of this macro. This macro really helps with keyword maintenance as we no longer have to define and maintain a “Other Fruits List”.
“$feature[<feature>]—This macro takes the union of all keywords defined for every category for the specified feature (the parameter is mandatory). If the mentioned feature is feature for which this category is defined, this category is obviously excluded from the union. This is very useful in configuring the keywords of a feature associated with a parent node. Take for example the following hierarchy and assume that the “Dried Fruits” HS is further broken down into different types of fruits. If we have defined a feature called “Dried Item Type” and “Dried Fruit Type”, we could then configure the categorical value of “Dried Fruits” for the “Dried Item Type” feature with the keywords “$feature[Dried Fruit Type]”.
   Dried Items
      Dried Fruits
      Dried Vegetables
      Dried Nuts
$category[<feature.category>]—This macro is similar to the $feature macro mentioned above except only the keywords associated with the specified feature category are included.
$childCategories—This macro is best suited for use with shadow-features (features that are generally automatically created and mimic the HS hierarchy). It automatically adds the keywords associated with all the child-nodes. Note that child-nodes and categories are synonymous when dealing with shadow-features. Take for example the following hierarchy for heading 8508 in the US tariff. If the processor created a shadow feature, the feature name would be “HS_CODE_8508” and the categories would be “8508_0”, “8508.60.00.00”, and “8508.70.00.00”. Assuming that there is also another shadow feature at the chapter level called “HS_CODE_85” with a categorical value “8508”, the keyword configuration of “$childCategories” and “$Feature[HS_CODE_8508]” would be equivalent. It's easier to use “$childCategories” since the processor does not need to parameterize it and can be blindly copied to all non-leaf nodes that use shadow features.
   8508 Vacuum cleaners; parts thereof:
      With self-contained electric motor:
      8508.60.00.00 Other vacuum cleaners
      8508.70.00.00 Parts
$descendantCategories—This macro is best suited for use with shadow features but only really applicable if the keywords configured at a descendant nodes are not bubbled up to their parents. In that case, this macro collects keywords from all descendant nodes, not just the child nodes.

### Keyword Assistance

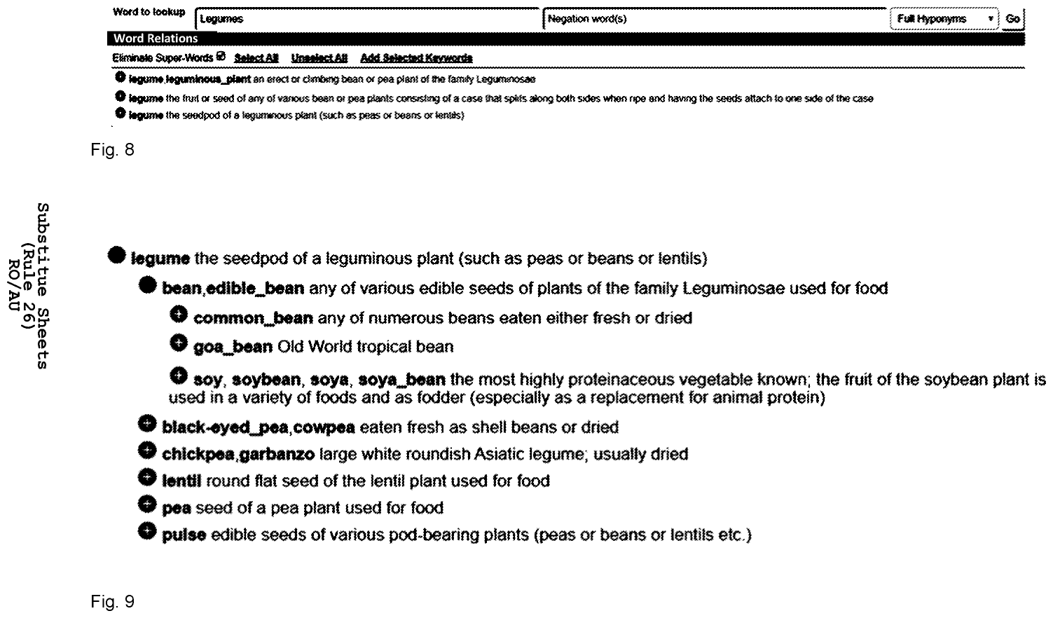

The keyword assistance helps generate a list of keywords that comprehensively covers a topic. In context, the topic is typically defined as a feature category. For example, the keywords that would describe “Leguminous vegetables” as mentioned by heading 0708. Processor can go to Google and search for “Leguminous vegetables” and sift through the information and assemble the list. However, it will likely be incomplete and potentially erroneous. A better way is to use the keyword assistance and type in “legumes” and search for full-hyponyms (informally, hyponyms are a collection of sub-sets/refinements of the term you are searching for). When processor does this search, it retrieves multiple definitions as in FIG. 8. Note that synonym terms will be listed on the same node. For example when the processor searches for animals, the processor gets just one definition but it lists the synonym terms animate-being, beast, brute, creature, and fauna in addition to animal on the same node.

After reading the definitions of legumes, the user can see that the third definition is the one the user is interested in. Expanding that node shows a full hierarchical set of hyponyms (or just the direct hyponyms had we selected “Direct Hyponyms” instead of “Full Hyponyms” in the drop down on the right). FIG. 9 shows the direct hyponyms of legume along with the hyponyms of bean/edible-bean in an interactive user interface, where the user can click on the controls to expand and collapse the individual terms.

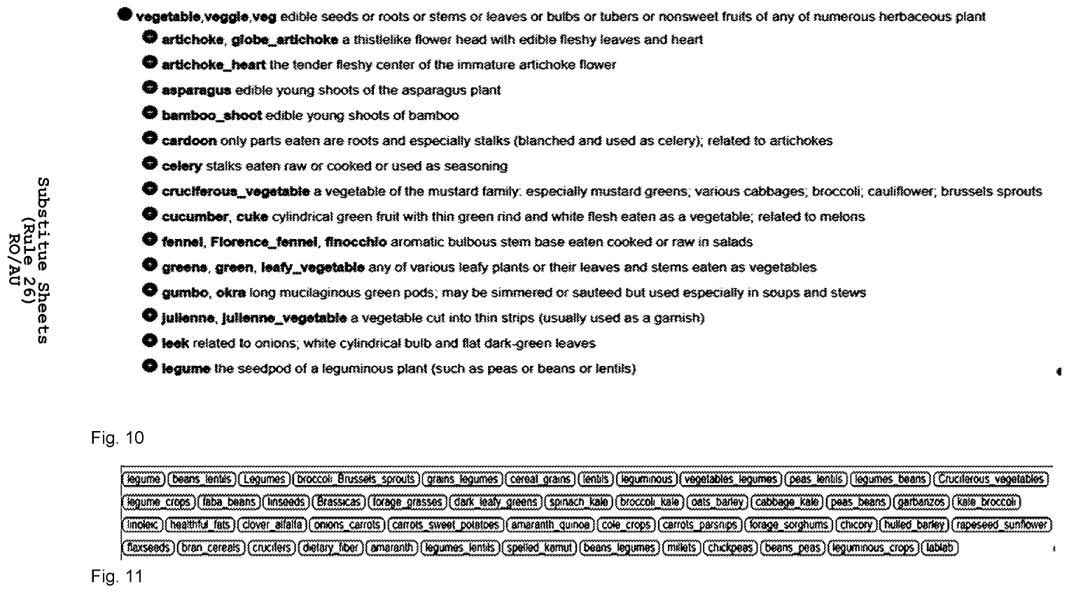

The user can either click on the individual terms to select them, click “Select All” to select all terms, or invoke the context-menu by right-clicking on a node and click the “Select All Terms” to select terms listed at that node or “Select All Child Terms” to select terms at that node and all its descendant nodes. To unselect selected terms, the user can click on them again. Once ready, click on the “Add Selected Keywords” option to add the selected terms and associate with the selected category. The related-words option display sister-terms for your search term. Sister-terms are obtained by taking the direct hyponyms of the hypernym of your term (a hypernym is a generalization . . . more formally the hypernym of a term's hyponym is the term itself). For example, the hypernym of legume is vegetable/veggie/veg and some of the direct hyponyms of this are shown in FIG. 10. Sister-terms can be helpful when you have an example of a term that belong to the current category and want to use it to find other additional related terms.

Synonyms, hyponyms, and related-words/sister-terms were all obtained using WordNet. The final option is contextual words. This makes use of Word2Vec and the contextual information that it has gathered by combing through a large corpus of text. It is not as precise but displays words that are most commonly listed in the same context to the word you search for. Often this can identify additional terms that were not found using WordNet. Contextual words do not display with their associated definition and are therefore displayed as tags that can be selected/un-selected and added in a similar fashion. FIG. 11 shows an example of contextual words of legumes.

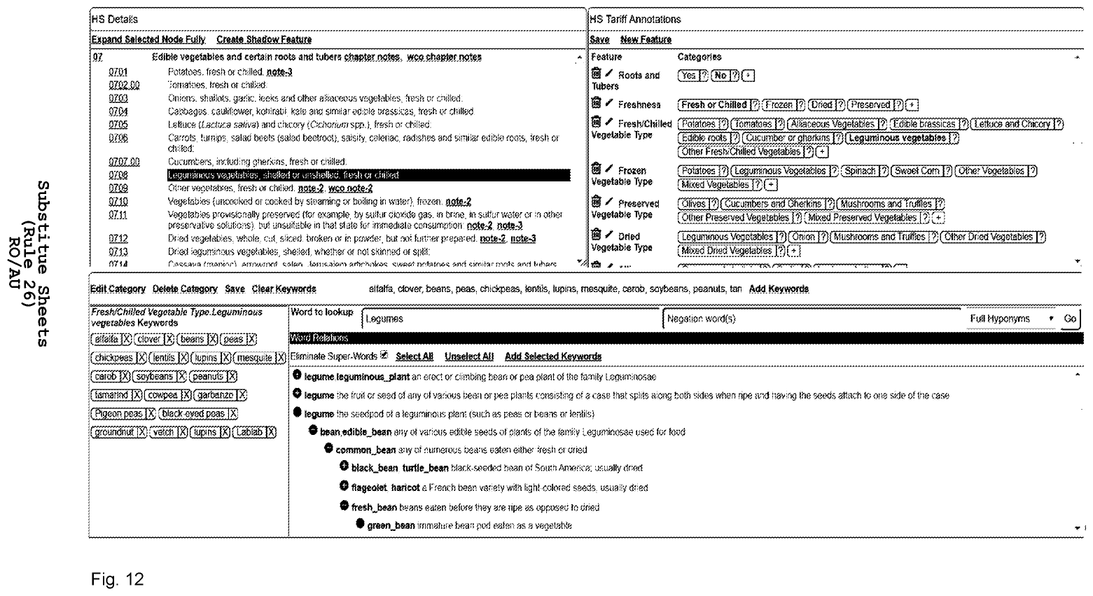

The keyword assistance is available in associated keywords with categories in both the component details page and annotation page. It's also available while configuring either a local or global named keyword-list. The most intuitive place to configure keywords is in the annotations page where the user can see the tariff hierarchy, annotated feature categories, and the keywords. A screen shot of this view is shown in FIG. 12.

### Tariff Annotations

The set of important product features that are defined within the classification component can be used to annotate the portion of the tariff that the component is designed to predict. In other words, the processor updates the text string associated with nodes of the classification tree or adds further decision aids that are not represented as a text string. In another example, the processor does not store the additional annotations in association with the nodes but directly into the corresponding classification component.

These annotations serve three distinct purposes:
1) Guardrails to validate ML model predictions: —A classification prediction from a model is checked to see if it conflicts with annotations along the path to the predicted HS involving any of the extracted characteristics. If there is a conflict, that prediction is discarded and the next best prediction is analysed. This continues, until a predicted HS is found that does not conflict. This is then returned as the top recommendation.
2) Determination of the set of features that a user is requested to validate for a predicted classification: The annotated characteristics along the path that could not be extracted are exposed to the user for confirmation that one of the annotated categorical values is accurate for each characteristic. If not, the user can click the categorical value for one or more characteristic that is incorrect and force the System to run through the process again. The updated characteristics are now added to the set of extracted characteristics and serve as guide-posts as defined in the first point.
3) Traversal of the tariff based on extracted or solicited features (in the absence of a ML model).

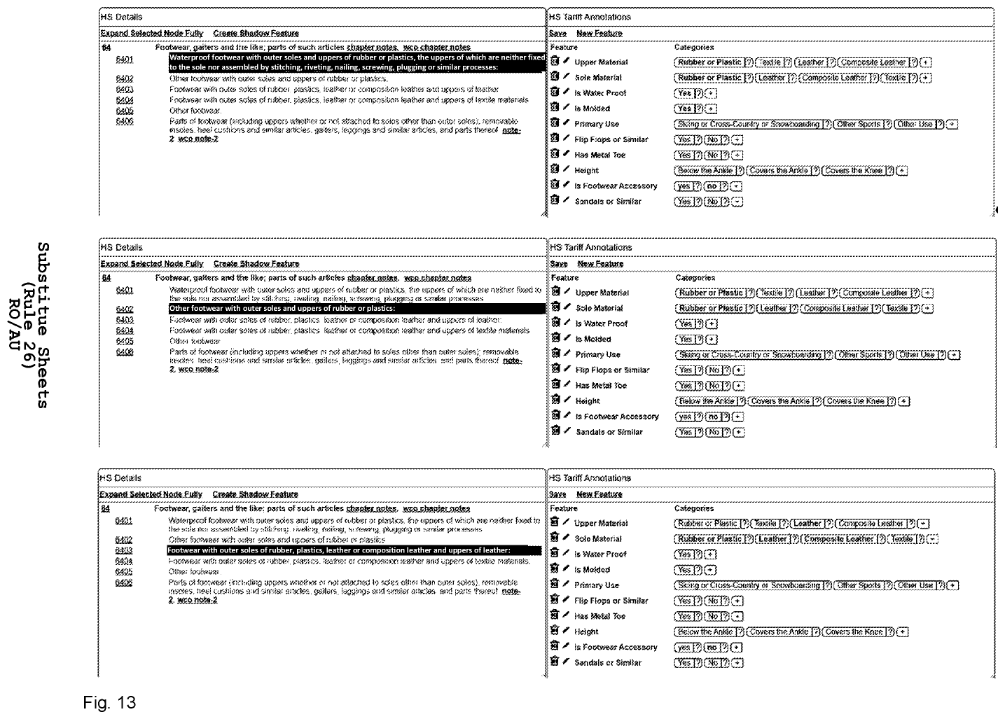

FIG. 13 shows three screenshots that show how annotated headings 6401, 6402, and 6403 of Chapter 64 are annotated using the product features. The figure shows that the annotations for heading 6403 inform the ML Solution that the upper-material needs to be made of leather and the sole-material needs to be made of rubber, leather, or synthetic-leather. The processor extracts these features for a given shoe product and can then use this for the three purposes mentioned above. Let's take an example and demonstrate each of these using the product-features and annotations we've shown here.

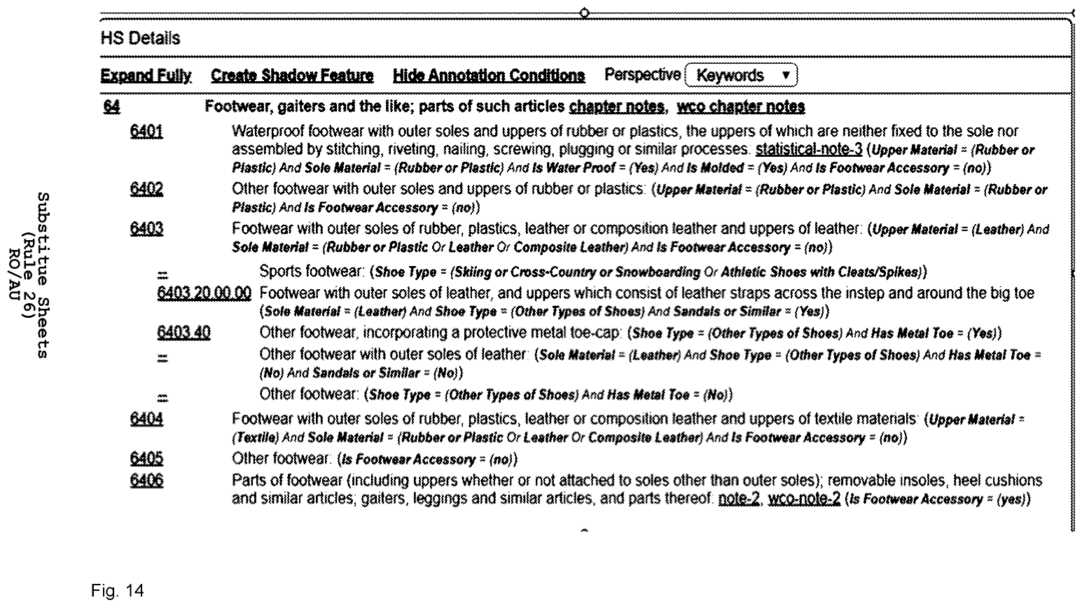

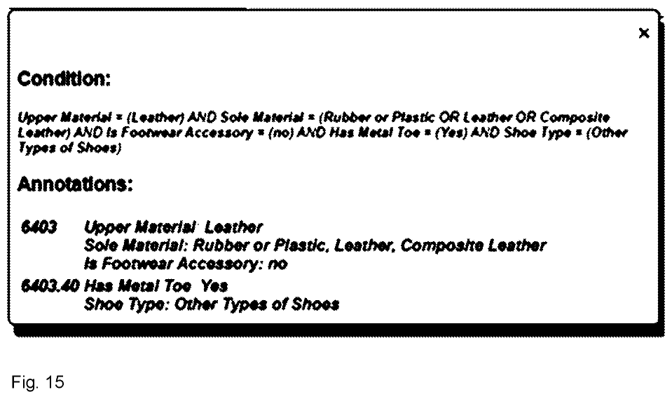

To get a comprehensive view of the annotations of this component, the user can click the “View Annotation Conditions” to see the annotation condition in the HS-tree. The user can toggle this off by clicking the “Hide Annotation Conditions” action. When viewing the annotation conditions for the Chapter 64 component, the tree view would appear as show in FIG. 14. To get a full view for a given HS, the user selects a HS node within the HS-tree and click the “Show HS Annotation Condition” action. This will show the annotation condition as well as the specific annotation for all nodes from that HS to the root. Clicking this action on 6403.40 would display what is shown in FIG. 15.

### Machine Learning Models

As mentioned above, the processor can use ML models to determine the correct categorical value (i.e. one of multiple options) for features or directly to predict a classification code. Each classification component can have multiple models along with features and annotations that all combine to predict a n-digit classification code. Note that ML models used to predict a classification can be trained with the features defined within the component to enhance its predictability. The System has comprehensive machine-learning support and each model can be configured with various features that are best suited for its intended use. Some of these features are described below.

### Training and Deployment Nodes

The System allows nodes (machines) to be configured for training, deployment, or both. A model definition is configured with the training and deployment node to be used for each purpose. Training a ML model with lots of training-data takes a powerful machine with lots of memory whereas deploying a trained model for predictions requires significantly less compute resources. However, the choice of deployment node is also dependent on the throughput requirements. If the compute nodes are AWS EC2 instances, they can be brought up and shut down through the application, allowing expensive nodes to only be online when required for training.

### Training Data Options

Models are trained using labelled training data. The System can use classified products or a CSV file as training data. When using product training data, the user can specify the subset of products in the System to use in training the model. CSV files can be uploaded and are stored in a document repository, and persisted in S3 when deployed in AWS. The format of a CSV file may consist of two columns, the label and product text.

Features extracted from each training-data can be passed as categorical features that are unioned with NLP based approaches of vectorizing unstructured text. The model definition allows the user to specify a list of features that should be included in the training along with the weight associated with those features vis-à-vis the vector that is generated from unstructured text. The training data is automatically pre-processed by the System to extract features, perform one-hot-encoding, and pass to the training process.

### Data Balancing and Validation

The System is able to automatically balance training data provided via either products or CSV so that each class (label) has more equitable number of training data. This is useful as many ML algorithms result in skewness of predictions if the training data itself is skewed. Balancing removes this skewness by capping the amount of training data retained for any class at either the median, minimum, or average across all classes. Balancing using minimum removes all skewness but also results in the highest reduction of the training set. The average and median approach improve balancing (versus not doing anything) while limiting the overall reduction of the training set. The user can also choose to perform no balancing in which case the entire training data set will be used.

### Vectorization and Algorithms

ML algorithms operate on numeric vectors. Product are first converted to vectors before they are included in training or before a prediction for a given product can be processed. The same vectorization that is applied to the training set is applied to a product being queried. The idea is that the vector contains a number of features where each feature is an individual property or characteristic of the item being observed. In some examples, there are two types of features: One-hot-encoded categorical features that the processor extracts and NLP based features generated from unstructured text. The processor may also use product attributes such as price, weight, etc. directly as numerical features.

Unstructured text such as a product title and description are converted to a numerical vector by tokenizing the text into words and then processing the words to create a vector. The model definition enables converting words into numerical values by computing each words term frequency-inverse document frequency (Tf-Idf) or by using word-embeddings from pre-trained Word2Vec or FastText models (models can be trained in different ways . . . i.e. common-crawl, Wikipedia, etc.). The last option is to train a FastText model and use the word-embeddings from the trained model. This is a viable solution if there is a large amount of training data such that good word contexts can be learned.

Finally, the model definition specifies the type of ML algorithm to use to train the model. Example algorithms include Support Vector Machine (SVM), Nearest Neighbor, FastText (only if you want to build your own word embeddings), and Multi-Layer Perceptron (MLP). The model may be a binary model, such as One-Class SVM.

Given a set of training examples, each marked as belonging to one of two categories, an SVM training algorithm builds a model that assigns new examples to one category or the other, making it a non-probabilistic binary linear classifier. An SVM maps training examples to points in space so as to maximise the width of the gap between the two categories. New examples are then mapped into that same space and predicted to belong to a category based on which side of the gap they fall.

More formally, a support-vector machine constructs a hyperplane or set of hyperplanes in a high- or infinite-dimensional space, which can be used for classification, regression, or other tasks like outliers detection. Intuitively, a good separation is achieved by the hyperplane that has the largest distance to the nearest training-data point of any class (so-called functional margin), since in general the larger the margin, the lower the generalization error of the classifier. In some examples, the sets to discriminate are not linearly separable in that space. For this reason, the original finite-dimensional space be mapped into a much higher-dimensional space, making the separation easier in that space.

To keep the computational load reasonable, the mappings used by SVM schemes can ensure that dot products of pairs of input data vectors may be computed easily in terms of the variables in the original space, by defining them in terms of a kernel function k(x, y) selected to suit the problem. The hyperplanes in the higher-dimensional space are defined as the set of points whose dot product with a vector in that space is constant, where such a set of vectors is an orthogonal (and thus minimal) set of vectors that defines a hyperplane. The vectors defining the hyperplanes can be chosen to be linear combinations with parameters a, of images of feature vectors x, that occur in the data base. With this choice of a hyperplane, the points x in the feature space that are mapped into the hyperplane are defined by the relation Σᵢαᵢk(xᵢ, x)=constant. Note that if k(x, y) becomes small as y grows further away from x, each term in the sum measures the degree of closeness of the test point x to the corresponding data base point xᵢ. In this way, the sum of kernels above can be used to measure the relative nearness of each test point to the data points originating in one or the other of the sets to be discriminated. Note the fact that the set of points x mapped into any hyperplane can be quite convoluted as a result, allowing much more complex discrimination between sets that are not convex at all in the original space.

A multilayer perceptron (MLP) is a class of feedforward artificial neural network (ANN). An MLP may consist of at least three layers of nodes: an input layer, a hidden layer and an output layer. Except for the input nodes, each node is a neuron that uses a nonlinear activation function. MLP utilizes a supervised learning technique called backpropagation for training. Its multiple layers and non-linear activation distinguish MLP from a linear perceptron. It can distinguish data that is not linearly separable.

Two example activation functions are both sigmoids, and are described by

$$y ( {v}_{i} ) = tanh ( {v}_{i} ) and$$

$$y ( {v}_{i} ) = {( 1 + {e}^{- {v}_{i}} )}^{- 1} y ( {v}_{i} ) = tanh ( {v}_{i} ) and$$

$$y ( {v}_{i} ) = {( 1 + {e}^{- {v}_{i}} )}^{- 1} .$$

The rectifier linear unit (ReLU) may also be used as one of the possible ways to overcome the numerical problems related to the sigmoids.

One example comprises a hyperbolic tangent that ranges from −1 to 1, while another example uses the logistic function, which is similar in shape but ranges from 0 to 1. Here y, is the output of the i th node (neuron) and v, is the weighted sum of the input connections. Alternative activation functions have been proposed, including the rectifier and softplus functions. More specialized activation functions include radial basis functions (used in radial basis networks, another class of supervised neural network models).

The MLP may consist of three or more layers (an input and an output layer with one or more hidden layers) of nonlinearly-activating nodes. Since MLPs are fully connected, each node in one layer connects with a certain weight wᵢⱼ to every node in the following layer.

Learning occurs in the perceptron by changing connection weights after each piece of data is processed, based on the amount of error in the output compared to the expected result. This is an example of supervised learning, and is carried out through backpropagation, a generalization of the least mean squares algorithm in the linear perceptron.

The degree of error in an output node j in the nth data point (training example) is eⱼ(n)=dⱼ(n) −yⱼ(n), where d is the target value and y is the value produced by the perceptron. The node weights can then be adjusted based on corrections that minimize the error in the entire output, given by

$$ℰ ( n ) = \frac{1}{2} {\sum }_{j} {e}_{j}^{2} ( n ) .$$

Using gradient descent, the change in each weight is

$$Δ {w}_{ji} ( n ) = - η \frac{\partial ℰ ( n )}{\partial {v}_{j} ( n )} {y}_{i} ( n )$$

where y, is the output of the previous neuron and η is the learning rate, which is selected to ensure that the weights quickly converge to a response, without oscillations. The derivative to be calculated depends on the induced local field vⱼ, which itself varies. It is easy to prove that for an output node this derivative can be simplified to

$$- \frac{\partial ℰ ( n )}{\partial {v}_{j} ( n )} = {e}_{j} ( n ) {ϕ}^{′} ( {v}_{j} ( n ) )$$

where ϕ′ is the derivative of the activation function described above, which itself does not vary. The analysis is more difficult for the change in weights to a hidden node, but it can be shown that the relevant derivative is

$$- \frac{\partial ℰ ( n )}{\partial {v}_{j} ( n )} = {ϕ}^{′} ( {v}_{j} ( n ) ) {\sum }_{k} - \frac{\partial ℰ ( n )}{\partial {v}_{k} ( n )} {w}_{kj} ( n ) .$$

This depends on the change in weights of the k th nodes, which represent the output layer. So to change the hidden layer weights, the output layer weights change according to the derivative of the activation function, and so this algorithm represents a backpropagation of the activation function.

### Results Refinement

The results (labels or classes) predicted by a model either predict a categorical value (when used to determine a feature) or a classification code. The results can be refined using a pipeline (or series) of steps as defined below. Typically no refinement is performed but when required this refinement can be extremely helpful.

Reduction—A reduction step works best on models that predict an HS classification code and can prune the predicted classification from an n-digit classification code to a m-digit classification code where n>m. This is useful when a model is trained on classifications codes that are more granular than what is required. For example, a model can be trained at a heading level (4-digit HS) and the results pruned to a chapter level (2-digit HS). This can yield better results than training and predicting at 2-digit HS. The reduction step should specify a de-dupe method of either Max, Average, or Sum.

Map—A mapping step is best used with models that predict categorical values for a feature (though they can also be used with models that predict HS classification codes). The mapping configuration allows multiple classes to be mapped to a single class. Like the reduction step, it should specify a de-dupe method.

Eliminate—A elimination step is used to filter out certain classes from the prediction list. This can be useful if the intention is to ensure that certain classes are never predicted, though they may have been present in the training set.

### Training and Deployment Options

Once a model definition is configured, the user can elect to train the model on an ad-hoc basis by bringing up the model definition and clicking the “Train Model” option or by scheduling it. The schedule options include a one-time training request at some date/time in the future or on a recurring weekly or monthly basis. If the model training is done using a growing set of products classified using the System or a CSV that is periodically updated, a recurring schedule will ensure that the model is getting smarter over time by learning from more and more training-data.

A part of the training data (10% by default) is used to compute the accuracy of the trained model. A full history of previous trainings of a given model are visible in the model-training history page. This page allows a view into the full model definition that was used for each historical training along with the computed accuracy. Any of the previously trained models can be manually deployed at any time.

The system allows training from products loaded for model training or via a CSV. It also allows classifications that are performed using the application to be promoted to the training set to support continuous training. Some examples are using FastText word-embeddings to process the name, short-description, and long-description text attributes and union that with one-hot encoded representation of the selected categorical product features (upper-material, sole-material, usage, coverage, metal-toe, water-proof, and mould). The processor assigns higher weight to the NLP vs the categorical features, 60% to 40%. Finally, the processor usen the Multi-layer Perceptron ML algorithm to train our model.

### Classification Flow

Below is the current definition of the model that is used to predict the correct chapter to assign to a commodity which then determines the next classification component to route the product to. The model is used to predict the “Chapter” feature (as you can see from the Invocation HS/Feature input field). The individual chapters are defined as categorical values that are then annotated against the chapters. It is noted that:
The model will be trained on a large EC2 instance with 64 cores and 256 GB or RAM.
Once trained it will be deployed on a default hosting node (a smaller machine). The model may be auto-deployed after it is trained.
The training is done using training data with no balancing and 10% validation
The model will generate a 4-digit HS code even though the intention is a prediction of a 2-digit chapter (using results refinement)
The processor uses FastText to create a vector from our unstructured text (product name only) and uses the MLP algorithm to train the model.
The processor also passes in a ChIndicator feature to be included in the training. This will be unioned with the FastText feature with a weight ratio of 0.5 to 0.5.
The resolution refinement is configured with two steps . . . . First is to reduce the 4-digit HS code to 2 digits using the “reduce” step with a de-dupe method of sum. The second step is a “map” that maps classes 50,51,52,53,54,55,56,58, and 60 to the class “Textile” and classes 61,62 to “Apparel” with a de-dupe method of sum. We then use feature annotations to resolve “Textile” and “Apparel” using feature extractions and annotations.

### Classification Recommendation Flow

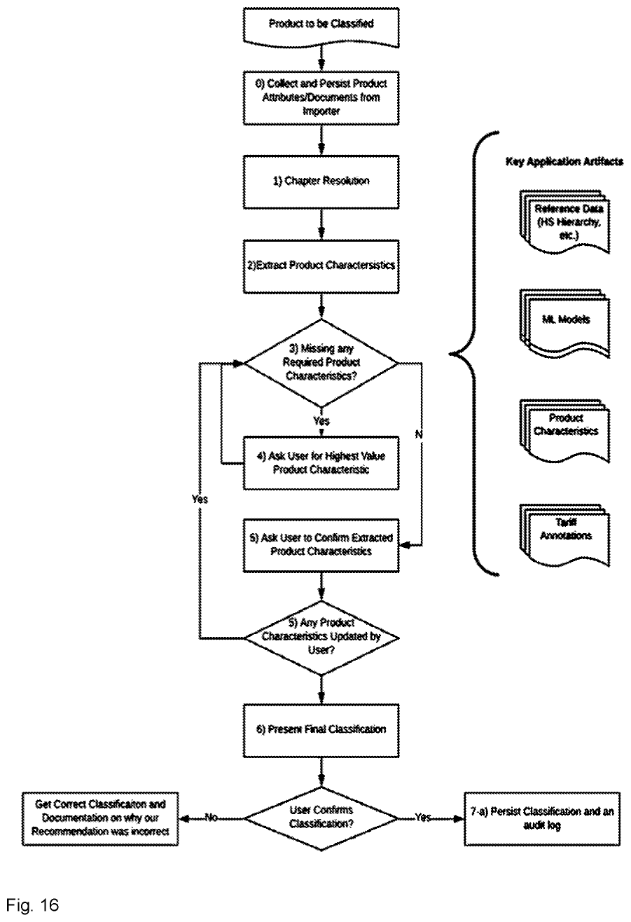

The end-to-end classification workflow is shown in FIG. 16. This flow aims at getting an informed classification recommendation based on important product characteristics and relies heavily on NLP to extract these features and annotations to navigate the tariff.

Step 0): In the “Product Entity” section above there is disclosed an ability for a user to create and supplement a product, including attachments, via a combination of an API and UI. This allows sufficient product information to be gathered and updated before that product is classified.

Step 1): The System does not dictate that the classification flows in exactly this way, but based on the current configuration we first determine which of the 97 chapters that a product should be classified into (as described in the example ML model in the previous section).

Step 2): Before the processor can extract product characteristics, the important characteristics for a given product-segment (or chapter) are determined. It is defined how this is accomplished by configuring a set of features within each classification component in the “Product Features & Extraction” section above.

Step 3): The “Tariff Annotations” section above described how the processor annotates the tariff with the set of features that are defined within each classification component. These annotations serve as the rules that determine which node the processor navigates to. If the processor has the product features required to traverse to a leaf-node, the processor can skip step-4 and go directly to step-5.

Step 4): When the processor needs to obtain additional product features, the System determines the feature that has the highest reduction score (a score that represents the average number of nodes from the current viable set that will be eliminated) and presents that to the user. The user is asked to provide a value for this feature. In one specific example the user is being asked to provide what the upper-material of a shoe is made of (rubber, textile, leather, synthetic-leather, or something else).

It is also noted that the system allows the user to go to another chapter if they feel the current chapter, chapter 64, is incorrect. If the user were to click on the link, they would see the chapters that the ML model predicted along with the corresponding confidence and let the user pick an alternative chapter.

In one example, the user interface does not list all extracted features but rather, only the ones that are deemed to be relevant. For example, the System also auto-extracted that the usage of the shoe is “Other Sports” but that is not listed yet because it may or may not be relevant depending on what the user inputs that the uppers of the shoe are made of. For now, it is showing the user that it has extracted that the “Sole Material” is made of “Rubber or Plastic” and that this is a shoe and not a shoe-accessory, the latter is determined using a model. The user can click on the determined category and change if a corrective action needs to take place.

In other words, the user interface comprises an indication of feature values for each classification component separately (as there are no features that are used across the entire pipeline). When the user changes a feature value, this causes re-creation of the pipeline of classification components as the changed feature value may lead to a different branch in the classification tree. That is, the classification components downstream from the changed feature value are re-created. It is noted that the user interface may only show the features involved in the current pipeline (i.e. a single classification path), while there is a large classification tree of components that is hidden from the user and re-visited when the user changes one of the feature values. It is further noted that changing feature values of an earlier component in the pipeline has a greater effect on the outcome than changing feature values of a later component in the pipeline because a smaller number of leaves is accessible due to the classification earlier in the pipeline that remains unchanged.

Further, in response to the user changing the feature value, the classification component re-trains its classifier by taking the user input as a training sample and further reducing the error between the user provided feature value and the predicted feature value calculated by the classifier. This way, the classifier component learns from the user's changes to the feature value, which improves future classifications.

Assuming the user does not change anything and continues by picking “Textile” for the upper material, this would result in a six-digit classification (since this component is designed to only go up to six-digits). The System then displays all the extracted features that the recommended classification is based on and asks the user to validate that all of those features are correct, by click on the check-image next to each feature At this point the user can add a note and either confirm the recommended classification or make changes to one or more of the extracted features and click “Update Recommendation”.

Finally note that the user can see the HS-hierarchy that their recommended classification code is listed in and has the ability to see any relevant WCO and country notes within that hierarchy.

Step 5): Once all the product features required to navigate to a leaf-HS have either been extracted or obtained from the user, the user is asked to validate that the set of product features that were automatically extracted from the product are correct. This is important as the recommended classification is based on these features. The user can update any of the extracted feature and update the recommendation by going back to step-3 in the process flow. If the user confirms that all extracted features are correct, the user interface will present the recommended classification.

Step 6): The user is presented with the recommended classification and can either accept that classification or update the correct classification code. If the recommended classification is updated, the System will make note of this discrepancy for analysis and potential corrective actions to features and annotations that led to that recommendation.

If the recommended classification is accepted, the user notes and a full audit of the extracted features, user-provided features, and the user's confirmation are saved in step 7-a) as an audit to show the due-diligence that was followed in obtaining the classification.

In the flow of FIG. 16, the aim is to predict a chapter and then use features and tariff annotations to navigate through the remainder of the tariff by either extracting features or asking the user specific questions. However, there may be scenarios for which annotations do not work well. In these situations, the processor uses ML models instead. A good example is chapter-84 where there are 87 distinct headings (chapter-85 is another good example with 48 distinct headings). There is no efficient or user-friendly way to create features and annotate the tariff to go from chapter to heading. It would likely result in asking for a “product-type” feature with 87 options, an experience not too different from navigating the raw tariff. Therefore, to go from one of these two chapters to a four-digit heading, the processor will leverage a combination of ML and NLP. There may also be similar exceptions deeper in the tariff. In general, the processor will leverage ML models when annotations are not feasible.

The above classification flow ensures that the classification code that is assigned to a commodity is based on a set of features pertinent to its product-segment. It requires the tariff to be annotated which serves as a sophisticated decision tree. It is important to note that the System can also act in a mode that relies more heavily on ML without knowing all the product features and use the annotations to ask the user to validate that certain product-feature assumptions are correct.

Alternative Classification Recommendation Flow—ML Model Invocation with Guard Rail Correction & Assertion

In this mode, the processor invokes ML models trained within classification components to obtain final classifications using only the product features the processor is able to auto-extract. The user is not prompted for any missing product features. The partial product information is vectorized and passed to a ML model to makes a statistical prediction. This prediction is then checked against tariff annotations, which act as guard-rails. If the top prediction does not comply with the guard-rails, the processor discards the prediction and moves to the next best prediction. This is repeated until the processor finds the first prediction that does comply. That prediction is presented to the user along with the assumed value of the set of relevant product features we were not able to extract.

Like the previous flow, the user is presented to confirm all extracted features and asked to validate that the value for the unextracted features would comply with the guard-rails on the path to the recommended classification. If the user does not assert and corrects one or more features, the product features are updated and the flow is repeated. This mode will also function with partial or no product feature definitions or annotations. It effectively removes the automated and user-asserted corrections that are possible only when product features are defined and annotated.

The disclosed approach to classifying products is to combine state-of-the-art NLP and ML concepts with domain-specific features of the HS tariff. The Solution makes informed classification recommendations based on a minimally viable set of product features. The ability to define these product features and annotate the tariff not only informs the Solution of this minimally viable set but also facilitates its ability to guide users through classifying in segments of the tariff where it does not yet have enough quality training-data to build ML models. Eventually when the training-data is available, predictive ML models take over and the annotations play the role of guardrails instead of rules.

### Technical Classification Flow

The below steps outline an end-to-end classification flow with technical details that demonstrates how classification-components are pipelined together to classify a product. It also has details on how each component uses a combination of automated features extraction, ML models, feature annotations, and user-solicited feedback to expand a product's classification.

Step 1: A product is passed in for classification with an initial classification-code of NO_CLASS (this is an indication that the product has no existing classification).

Step 2: The System attempts to find a classification-component to process this product via a component-resolution process. The component resolution involves identifying a component by looking for a classification-component whose HS-filter matches the product's current classification (as stated in step 1, the initial classification is NO_CLASS so it will initially look for a component whose HS-filter has been configured to NO_CLASS). In most cases the System should only resolve to a single component. However, if multiple components meet the filter, the System arbitrarily selects one. If there are no components that meet the filter criteria, the current classification of the product is returned as the recommended classification and the System proceeds to step 6.

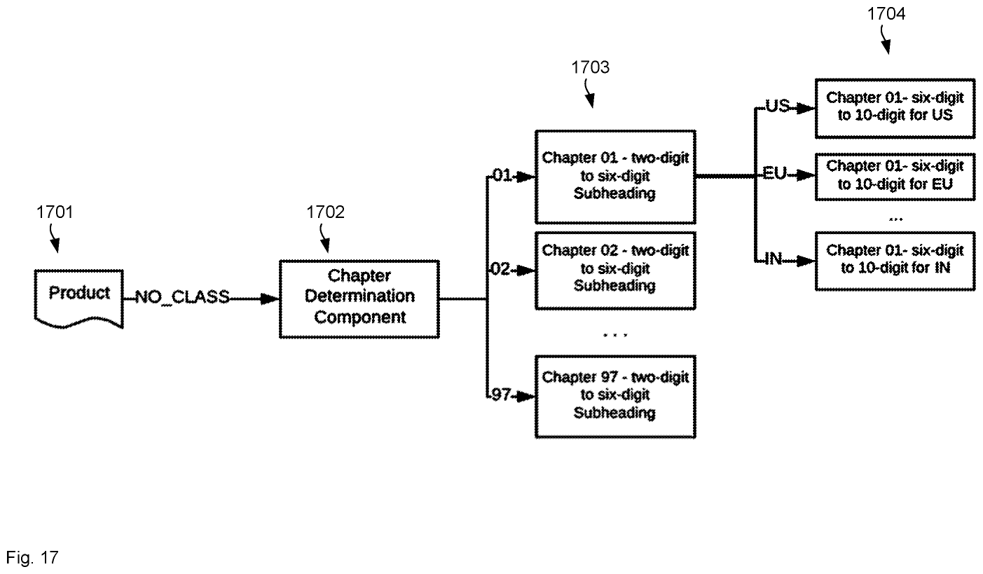

Step 3: The product is passed to the resolved component. Each component specifies the length of the HS code it intends to classify the product to. Once the product is classified to a code that is greater-than-or-equal to the configured target-length, it exits that component and the System searches for another component that can process this product with from its updated classification-code to a more granular classification by repeating step-2. This is referred to as a component pipeline and intends the full classification to be generated by multiple classification components. Based one example configuration, a full classification code is generated by pipelining a minimum of three components as shown in FIG. 17. The first component 1701 take the classification from NO_CLASS to 2-digits (country-agnostic), the second component 1702 takes the 2-digit classification to a six-digit classification (country-agnostic), and the third component 1703 will take if from 6-digits to the full country specific classification. It is noted that the System is generic in how it identifies and pipelines components and that the below is only based on the example configuration.

Step 4: Once a product is passed to a given component, the component is configured to advance the classification. It is noted that components can contain annotated features and models and that models are configured to predict either a classification-code or a feature. A product being processed maintains its current classification, which could be stored in a variable called CURR_CLASS. The component proceeds in the following manner.
a. Try and determine the value of each defined feature. This is done by one of the following two methods, given in order or preference. The component keeps track of the set of resolved features.
   i. Check if there is a model whose invocation-feature is set to this feature (the invocation-feature is configured as part of the model definition). If so, invoke the model and use the recommended classification as the value of this feature.
   ii. Search product attributes for keywords associated with each categorical value of this feature to see which value should be assigned to this feature. The feature specifies the list of product attributes the processor should search. The keyword search occurs after normalization takes place on both the keywords and text being searched. Keywords are lemmatized and the search-text is tokenized, removed of stop-words, and lemmatized. This normalization process is very important and allows the user to not have to specify every tense of a word (e.g. the user can specific just “mix” instead of “mix, mixed, and mixes”). The System also handles matching compound keywords consisting of up to four words. A feature is resolved if it one or more categorical values have been determined as viable for that feature. It is fully-resolved if only a single categorical value has been determined to be viable.
b. If length of CURR_CLASS is greater-than-or-equal to the configured target-length, the CURR_CLASS, the processor exits this component with CURR_CLASS as the recommended classification. This represents the test for the output condition at step 105 in FIG. 1.
c. Search to see if there is a model defined with an invocation-HS equal to CURR_CLASS (the invocation-HS is configured as part of the model definition). If so, invoke that model by converting the product to a vector as defined by the model definition. The model returns an ordered list of recommendations based on confidence. Each recommended classification is tested in order by the component against annotations between CURR_CLASS and the recommended classification and selects the first one that satisfies those annotations. In this case, the annotations are being used as guard-rails to ensure that a model does not recommend a classification that we know to be incorrect. If no annotations exist, the first recommended classification is used. We update CURR_CLASS with the recommended classification and go back to step-b.
d. If no model exists for the CURR_CLASS, the processor checks if it can refine by traversing the tariff to a child-node of CURR_CLASS using annotations. Recall that an annotation of a HS-Node involves specifying the set of categorical values that a given feature must be resolved to in order for that node to be a viable HS-node. A given HS-Node can be annotated with multiple features in which case all annotated features must resolve to one of the allowed categorical values. For example if an HS-Node with a description of “Men or boys pants” is annotated with “Gender=Men, Boys” and “Clothing Article=Pants”, then the “Gender” feature must be resolved to either “Men” or “Boys” and the “Clothing Article” feature must be resolved to “Pants” for this to be a viable node. The processor looks at annotations for each child-node and reduce the viable set from all child-nodes to only those whose annotations are satisfied. If the processor is able reduce this to just one child-node, the processor can update CURR_CLASS to that child HS and go back to step-b.
e. If the processor reaches this step, it was unable to refine CURR_CLASS any further via step-c or step-d. If this classification request is not being performed in an interactive manner by a user, the processor exits this component with CURR_CLASS, even though CURR_CLASS has not reached the target-length. If this is an interactive classification, the System looks for features that are not fully resolved that would help reduce the list of viable child-nodes. From this set of potential features, we identify the feature with the highest reduction score (a measure of the expected number of child-nodes we would be able to eliminate from the set of viable child-nodes if this feature was resolved) and solicit the user for his feature. Once the user has provided the value for the feature, the processor goes to step-d to check if the resolution of this feature enables navigation to a child-node or if user input is required for additional features. It is also possible that there are no additional features that can be resolved that would enable a further reduction of the viable child-nodes. In this case the user is directly presented with the viable child-nodes and asked to select the appropriate one. In this case, the user-selected child HS is used to update CURR_CLASS and go to step-b.

Step 5: The System records all feature extractions, model invocations, and user-solicitations that led to traversing this component to serve as an audit. The processor repeats step-2.

Step 6: If the classification is being performed by an automated process, the final classification and audit is persisted with the product. If the classification is being done in a user-interactive session, the final classification and all auto-extracted features that the classification is based on is presented to the user. If the classification was partially generated via a ML-model, the processor may also present acceptable values for unresolved features that were annotated (see the mention of guard-rails in step 4-c). The user has the option to accept the classification by confirming all presented features are correct and entering a classification-comment. The classification, user-id, user-comment, and a full audit report are persisted with the product. The user may decide that one or more of the presented features need to be corrected, causing the System to update the recommendation based on this new information by going back to step-1. The user corrected features are carried throughout the classification process and supersedes any other method of determining the value for these features.

### Computer System

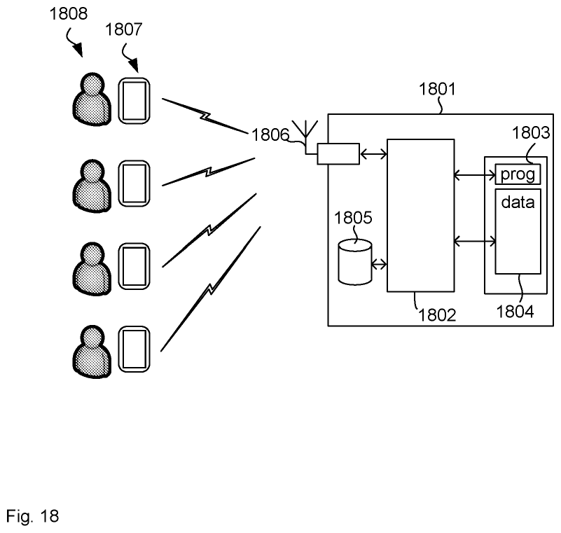

FIG. 18 illustrates a computer system 1801 for classifying a product into a tariff classification. The computer system 1801 comprises a processor 1802 connected to a program memory 1803, a data memory 1804, a database 1805 and a communication port 1806. The program memory 1803 is a non-transitory computer readable medium, such as a hard drive, a solid state disk or CD-ROM. Software, that is, an executable program stored on program memory 1803 causes the processor 1802 to perform the methods disclosed herein, including the methods of FIGS. 1, 5a, and 5b. That is, processor 1802 determines a classification of a product by iteratively selecting classification components, determining features and feature values and generating a user interface for the user to provide missing feature values. The term “determining a classification” refers to calculating a value, such as an 8-digit classification code, that is indicative of the classification of the product. This also applies to related terms.

The processor 102 may then store the classification on data store 1804, such as on RAM or a processor register. Processor 1802 may also send the determined classification and/or the generated user interface via communication port 1806 to client devices 1807 operated by users 1808.

The processor 1802 may receive data, such as a product characterisation, from data memory 1804, database 1805 as well as from the communications port 1806 as provided by the users 1808.

It is noted that the number of different products that are crossing borders is immense and for each product it is necessary to determine a classification. Therefore, the number of users 1808 and respective client devices 1807 is high (e.g. over 10,000). As a result, the computational efficiency of the classification algorithm is important to enable timely classification of each product. Further, the refinement and training of the classification methods should be performed regularly to account for any changes in the classifications. this refinement and training can also easily lead to a processing load of processor 1802 which jeopardises timely classification. The disclosed solution provides a computationally efficient way for classifying as well as refinement and learning with potential user input. Therefore, the disclosed methods are able to process the high number of requests in a short time (e.g. less than 1 s).

It is to be understood that any kind of data port may be used to receive data, such as a network connection, a memory interface, a pin of the chip package of processor 1802, or logical ports, such as IP sockets or parameters of functions stored on program memory 1803 and executed by processor 1802. These parameters may be stored on data memory 1804 and may be handled by-value or by-reference, that is, as a pointer, in the source code.

The processor 1802 may receive data through all these interfaces, which includes memory access of volatile memory, such as cache or RAM, or non-volatile memory, such as an optical disk drive, hard disk drive, storage server or cloud storage. The computer system 1801 may further be implemented within a cloud computing environment, such as a managed group of interconnected servers hosting a dynamic number of virtual machines.

It is to be understood that throughout this disclosure unless stated otherwise, nodes, edges, graphs, solutions, variables, classifications, features, feature values and the like refer to data structures, which are physically stored on data memory 1804 or database 1805 or processed by processor 1802. Further, for the sake of brevity when reference is made to particular variable names, such as “classification” or “characterisation” this is to be understood to refer to values of variables stored as physical data in computer system 1801.

The methods shown in FIGS. 1, 5a, and 5b are to be understood as a blueprint for the software program and may be implemented step-by-step, such that each step in those figures is represented by a function in a programming language, such as C++ or Java. The resulting source code is then compiled and stored as computer executable instructions on program memory 1803.

### Example

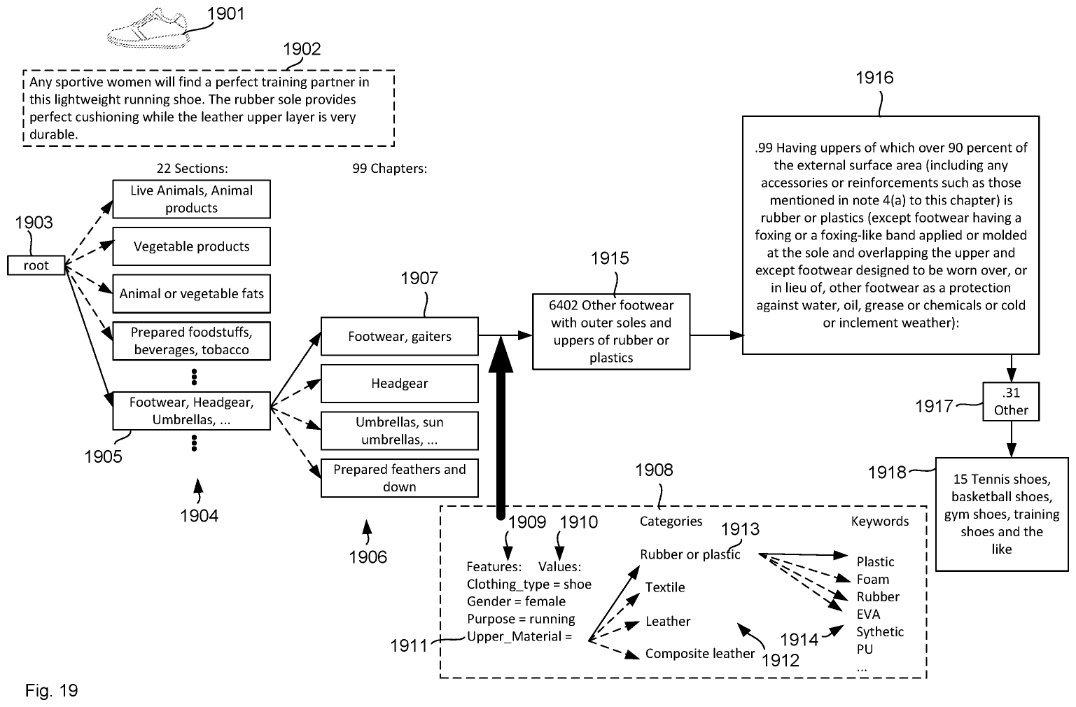

FIG. 19 illustrates an example of classifying a product 1901 into a tariff classification. Product 1901 is associated with a product characterisation 1902. In this example, the product characterisation is a marketing text, which illustrates how the proposed solution is not limited in application to structural or purely technical characterisations. It is also noted that the characterisation 1902 has been pasted into the classification search on the HTS website, which resulted in a classification of “Fish, fresh or chilled—Flat fish—Sole”, perhaps because the word ‘sole’ is the first that matches a classification. Clearly, this classification is inaccurate.

FIG. 19 shows a part of the tariff classification tree where nodes are shown as solid rectangles. A root node 1903 represents the NO_CLAS classification and has as children 22 section nodes 1904, where only a footwear section 1905 applies. The footwear section has multiple child nodes within 99 chapters 1906. Some examples disclose herein provide for a classification component that classifies product 1901 into one of the 99 chapters 1906 thereby effectively skipping the classification into one of the 22 sections 1904. This reduces computational effort since fewer classifiers need to be trained and evaluated.

In a further example, each of the 99 chapters are represented by respective classification components as indicated by the solid rectangles at 1906 (not all 99 rectangles are shown—only those for section 64 at 1905 for footwear). In this case, the NO_CLASS classification component has classified the product 1901 into section 64 at 1907. The numeral 1907 now also represents the chapter 64 classifier for the additional digits of the classification. The chapter 64 classifier 1907 is shown in more detail at 1908.

In particular, there are a number of features 1909 (left of the ‘=’ symbol). Some of the features 1909 already have a value 1910 (right of the ‘=’ symbol) assigned to them. For the last feature 1911, no value has been found yet. Therefore, the processor obtains multiple options 1912 with the aim of selecting one of the portions 1912 as a product feature value. Each of the options 1912 is associated with one or more keywords. For example, the first option 1913 is associated with a number of keywords 1914. in this case, none of the keywords match for the upper material. Therefore, the processor proceed to the next option. For value option ‘leather’ the keywords would include ‘leather’ (not shown). This matches the upper layer specification in the characterisation 1902. As a result, the processor selects the third option ‘leather’ as a value for the upper_material feature.

Now, all features have an assigned feature value, so the product can be classified. If a feature was missing, the processor would generate a user interface to present the different options 1913 to the user for selection. Importantly, not all features are provided to the user since some of the features can be assigned to options relatively clearly, so no user input is required. This significantly reduces the burden on the user to classify this product, noting that the user did not have to select or enter anything to identify chapter 64 and the available options are already very specific for that chapter.

The remaining nodes 1915, 1916, 1917, and 1918 illustrate potential further classifications. In some examples disclosed herein, classification component 1907 for chapter 64 determines a 6-digit classification which relates to node 1916, that is, classification 6402.99. Classification component 1907 may then serve as a base-component for a country-specific refined-component to determine further 4 digits to reach node 1918.

### Feature Extraction Using Image Processing

Some features of a product may be more easily identified visually by humans and this means that humans can be used to train computers, i.e. the classification component, through the use of image processing and machine learning techniques, to learn how to identify these features. This is achieved by displaying a product image to a user and providing a user interface where the user can identify feature in the product image and provide a feature value. Some examples include “tightening at the bottom” for t-shirts or “welt” footwear. In such cases, the processor can train an image model to predict if that feature is present or not in the product being classified. To train such a model users examine 200 product images or more that have that feature and then tag that feature with a rectangle drown around it. The tagged images are then used to train a model that will be invoked when classifying a product by passing the image of that product to determine if that feature is present or not. This is effectively a Boolean model that returns “Yes” or “No” that is assigned to category to which the image model is associated.

The classification platform has the capability of collecting these images from various e-commerce sites, tagging the images through a work-queue, training a model, and then deploying it for use within the classification flow. More specifically, there are a significant number of images are readily available on the web—particularly shopping websites such as Amazon. However, the vast majority of these images are not classified into tariff classifications. So it is valuable to use this training approach and classify the images that already exist on the web into the correct tariff classifications.

In yet another example, the processor can receive a product image, such as by the user uploading one, and perform optical character recognition (OCR) on the image to extract text. This is particularly useful, where the product image is an image of the packaging of the product. The extracted text can then be used as the input product characterisation to the disclosed classification method. In that sense, the extracted text can be seen as a sort of product description. In a further example, the size of the text in the product image can be used to prioritise larger parts of the text. This larger size can be used as the name of the product, which leads to a higher significance in the classification. To achieve this, the feature extraction may be performed on the product name first and then on the description where the features were not extracted to sufficient reliability. Further, the processor may use a threshold on the text size and evaluating the classification process on the text above the size threshold. If the classification process indicates that features are missing, the threshold can be lowered and the classification repeated.

For example, the process has been tested on a product image including a packaging of a toy from Lego from the Ninjago range. The OCR extracted Lego Ninjago as the name of the product since those words were the largest on the package. The extracted text for the product description was then by “Ninjago lego le dragon ultradragon agesledades 9+70679 The Ultra Dragon 951 pcs/pzs Building Toy Jouet de construction Juguete para Construir”. As can be seen, not all text was useful for classification but the extraction process extracted information from “Ultra Dragon”. The user was then informed that the “Books” feature has been determined to be “No” and that there are two possible chapters for classification of “25 salt, sulphur, earths and stone; plastering materials, lime and cement” or “95 Toys, games and sports requisites, parts and accessories thereof”. The user was then able to quickly decide between those two chapters as, clearly, only chapter 95 makes sense.

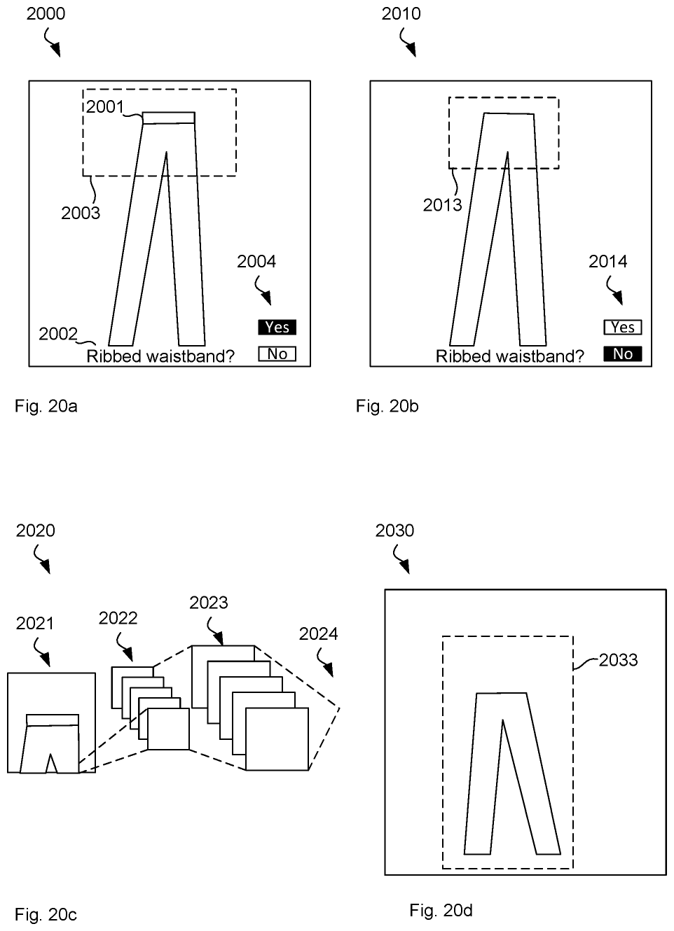

FIGS. 20a and 20b illustrate the training process of the image extraction in more detail. In particular, FIGS. 20a and 20b illustrate user interfaces, 2000, 2010, respectively. In this example, the processor extracts a binary feature value (yes/no) from an image of the product. Here, the product is a pair of pants and the feature is whether the pants have a ribbed waistband. FIG. 20a shows a positive training image with pants having ribbed waistband 2001. FIG. 20b shows a negative training image where the pants have no waistband. During training the feature value classifier, the image is shown on the user interface and the user selects the area that contains the feature in question. That is, the user interface comprises an indication 2002 of the feature in question and the user draws a bounding box 2003 around the feature in question. In other examples, the image area has a different shape, such as elliptical or freeform. The selected image area 2003 then serves as an input to a classification model.

In yet another example, the processor determines the image area automatically. The processor may present the automatically determined image area to the user in the user interface to enable adjustment by the user. The processor may store product images that were previously classified into specific nodes in the classification tree. In other cases, the processor has access to product images from other sources, such as online catalogues. The processor can then automatically determine the image area by comparing the current product image to the stored product images (classified into the current node of the classification tree or otherwise obtained). For example, the feature that needs to be extracted from the image is whether the pants have a ribbed waistband. This means the product has already been classified as pants. The processor can therefore compare the current product image against the images that were previously classified as pants (or accessed from a clothing catalogue). The processor then uses areas that show the most significant difference between the stored images and the current product image as the image area for feature extraction.

In one example, the processor calculates the most significant difference by calculating an average pixel value of the stored images. This may involve scaling and rotating the previous images to normalise those images so that the product always fills the entire image frame. The processor can then subtract the current product image from the average image to find the most significant pixels. That is, the pixels with the largest difference form the image area. This can be displayed to the user as a “heat map”.

In yet another example, the processor calculates an image embedding. That is, the processor calculates image features that most accurately describe the previously stored image. This can be achieved by an auto-encoder structure that uses each of the pixels of stored images as the input and as the output of one or more hidden layers. This is to train the hidden layers to most accurately describe the image. The hidden layers may be convolutional layers so that the processor learns spatial features that best describe the stored images. The processor can then apply the trained hidden layers to the current product image and calculate a difference between the output and the current product image. Where the output matches the current product image there is little difference, but where the output is different to the current product image, is where the processor identifies the image area to be used for feature extraction. Alternatively, the processor may train the hidden layer “from scratch” for the current product image and determine how different the result is from the result for the stored images. Essentially, the auto-encoder performs a principle component analysis and the processor determines the difference in principle components and maps that back to areas in the image. That is the weights from the hidden layer to the output layer indicate which image areas are influenced by which features in the hidden layer.

It is noted that features that have been extracted many times before likely have a well-trained classifier and do not require further user interaction for training. Therefore, product images with those features are likely well represented in the stored images. On the other hand, features that require further training are likely less represented in the stored images. Therefore, the stored images are more similar, in average, to the well-trained features. Which means the determination of an image area that is ‘unusual’ in the sense that it is different to the stored images, is a good candidate image area for training that missing product feature extraction.

FIG. 20c illustrates an example image classification model being a convolutional neural network (CNN) 2020. CNN 2020 comprises the input image 2021, multiple two-dimensional filters 2022 to be convoluted with the input image 2021 and resulting feature maps 2023. Further filters, subsampling, maxpooling, etc. are omitted for clarity. Finally, there is an output 2024 that provides a 0 for no ribbed waistband and a 1 for ribbed waistband present.

User interface 2000 further comprises a button 2004 for the user to select whether the currently shown image has a ribbed waistband. In FIG. 20a, the user has selected that there is a ribbed waistband, which means the output 1 is provided as a label together with training image 2021 in FIG. 20c. The processor can now calculate a prediction by evaluating the CNN 2020 and calculate the error between the prediction and the actual value (1). The processor can then perform back propagation and gradient descent to gradually improve the coefficients of the CNN 2020 to reduce the error between the prediction and the label provided by the user. In another example, CNN 2020 is pre-trained on other image data the processor only changes the coefficients of the last layer. FIG. 20b illustrates another example where, again, the user has drawn a bounding box but this time the user has selected no ribbed waistband 2014. Accordingly, the training image from bounding box 2013 is used as a learning sample for output 0.

As can be appreciated, the CNN 2020 has only two possible outputs 0 and 1, which means a relatively small number of training images is required to achieve a relatively good prediction. The number of training images is further reduced by the use of the bounding boxes since the learning is focussed on the distinguishing features, which makes the CNN 2020 more accurate after only a small number of training images, especially in the case where only the last layer is trained. It is noted that other classifiers, such as regression or random forest classifiers may equally be used and trained using iterative error minimisation.

Once the CNN 2020 is trained, it can be applied to an image of a product to be classified. FIG. 20d illustrates a user interface 2030 with an image of the product to be classified. This time, the user (which may be a different user to the “trainer” user) draws a bounding box 2033 to define the image area of the product.

It is noted that it may not necessary to draw a bounding box around the feature in question (e.g. the waistband). Since the CNN 2020 has been trained on the waistband area, it can apply that classifier to the entire image area 2033 and still label image area 2033 accurately. However, providing a user interface for the user to draw a bounding box may increase the confidence of the predicted classification, so for example, may bring the classification match from 30% to 95%. Receiving the bounding box from the user also reduces the computational complexity because fewer pixels need to be processed in the calculations, including the training and evaluation. As a result, the training and evaluation become faster and/or the average accuracy for classification increases.

It is noted here again that CNN 2020 does not classify the product into a tariff classification directly. Instead, CNN 2020 only determines one of the (potentially many) feature values in a specific component of the classification pipeline. For example, the upstream components have already classified the product as “clothing” and “trousers” but from the text description of the product the processor was not able to accurately predict whether the trousers have a ribbed waistband in order to proceed to further classification components (e.g. material, gender, etc.). Therefore, that specific classification component evaluates the trained CNN 2020 for the product image to extract that one feature value (e.g., ribbed waistband yes/no).

Once the feature is extracted, the classification pipeline proceeds as described above. In one example, the learning process is integrated into the classification process. That is, the tariff classification user interface indicates to the user that the extraction of the feature “ribbed waistband” was unsuccessful, or the user can indicate that the classification was incorrect. The user interface then prompts the user to draw bounding box 2003/20013 and select yes or no. This creates one additional training image. As more products are being classified and more training images are being generated by the multiple different users, the image feature extraction classifiers became more accurate.

In another example, the method is implemented as a web-based service, such that the CNN 2020 is only stored once for all users of the system. This means that every time one of the users manually selects the waistband, the same CNN is trained. This way, the burden of training the CNN 2020 is shared across multiple users, which significantly improves the training.

In this sense, there is provided a method for training a tariff classification pipeline. The method comprises identifying a feature for which a classifier is to be trained. The classifier is configured to generate a value for that feature (e.g. binary value) as the output of the classifier. The method then comprises presenting a product image to the user and receiving from the user an indication of an image area related to the feature and a label provided by the user for the product image. The method further comprises training the classifier on the image area using the label provided by the user. Finally, for another product, the method comprises evaluating the classifier on a product image to automatically extract the feature value for that product.

It is a further advantage of the proposed methods that refined-components for different countries can be defined as a child of any component in the tree. So for example, a refined component for a first country may classify from 8 digits to 10 digits while for a different country, the refined component may classify from 6 digits to 10 digits. This provides a flexible and maintainable collection of classification components that can be used computationally efficiently.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for classifying a product into a tariff classification, the tariff classification being represented by a node in a tree of nodes, the method comprising:
storing the tree of nodes, each node being associated with a text string indicative of a semantic description of that node as a sub-class of a parent of that node;
storing multiple classification components, each having a product characterisation as input and a classification into one of the nodes as an output;
connecting multiple classification components based on the product characterisation into a pipeline of independent classification components, the pipeline being specific to the product classification, each classification component of the pipeline being configured to independently generate digits of the tariff classification additional to the classification output of a classification component upstream in the pipeline, by iteratively performing:
selecting one of the multiple classification components based on a current classification of the product, and
applying the one of the multiple classification components to the product characterisation to update the current classification of the product;
responsive to meeting a termination condition, outputting the current classification as a final classification of the product.

2. The method of claim 2, wherein outputting the current classification comprises generating a user interface wherein the user interface comprises:
an indication of a feature value for each classification component of the pipeline separately, that is determinative of the classification output of that component, and
a user interaction element for the user to change the feature value to thereby cause re-creation of the pipeline of classification components downstream from the classification component for which the feature value was changed by the user interaction to update the current classification.

3. The method of claim 2, wherein the method further comprises re-training the classification component for which the feature value was changed using the changed feature value as a training sample for the re-training.

4. The method of any one of the preceding claims, wherein selecting the one of the multiple classification components is further based on determining a presence of one or more keywords in the product characterisation.

5. The method of any one of the preceding claims, wherein the multiple classification components comprise:
classification components that are applicable only if the product is unclassified; and
classification components that are applicable only if the product is partly classified.

6. The method of claim 5, wherein each of the classification components that are applicable only if the product is unclassified are configured to classify the product into one of multiple chapters of the tariff classification.

7. The method of claim 5 or 6, wherein the classification components that are applicable only if the product is unclassified comprise trained machine learning models to classify the unclassified product.

8. The method of any one of the preceding claims, wherein selecting one of the multiple classification components comprises matching keywords defined for the multiple classification components against the product characterisation and selecting the component with an optimal match.

9. The method of any one of the preceding claims, wherein the current classification is represented by a sequence of multiple digits and digits later in the sequence define a classification lower in the tree of nodes.

10. The method of claim 9, wherein the multiple classification components comprise:
multiple components for classifying the product into a 2-digits chapter; and
multiple components for classifying the product with a 2-digit classification into a 6-digit sub-heading.

11. The method of claim 9 or 10, wherein the termination condition comprises a minimum number of the digits.

12. The method of any one of the preceding claims, wherein iteratively performing comprises performing at least three iterations to select at least three classification components for the product.

13. The method of any one of the preceding claims, wherein applying the one of the multiple classification components to the product characterisation comprises:
converting the product characterisation into a vector;
test each of multiple candidate classifications in relation to the current classification against the vector;
accept one of the multiple candidate classifications based on the test.

14. The method of any one of the preceding claims, wherein applying the one of the multiple classification components comprises:
extracting a feature value from the product categorisation; and
updating the current classification based on the feature value.

15. The method of claim 14, wherein extracting the feature value comprises evaluating a trained machine learning model, wherein the trained machine learning model has the product characterisation as an input, and the feature value as an output.

16. The method of claim 14 or 15, wherein extracting the feature value comprises selecting one of multiple options for the feature value.

17. The method of claim 14, wherein the method further comprises determining the multiple options for the feature value from the text string indicative of a semantic description of that node.

18. The method of claim 16 or 17, wherein the multiple classification components comprise a base-component and a refined-component; and the refined-component is associated with multiple options for the feature value that are inherited from the base-component.

19. The method of any one of the preceding claims, further comprising training the multiple classification components according to a predefined schedule.

20. The method of any one of the preceding claims, further comprising refining one or more of the multiple classification components for a further product based on user input related to classifying the product.

21. Software that, when executed by a computer, causes the computer to perform the method of any one of the preceding claims.

22. A computer system for classifying a product into a tariff classification, the tariff classification being represented by anode in a tree of nodes, the computer system comprising:
a data store configured to store:
the tree of nodes, each node being associated with a text string indicative of a semantic description of that node as a sub-class of a parent of that node, and
multiple classification components, each having a product characterisation as input and a classification into one of the nodes as an output; and
a processor configured to connect multiple classification components based on the product characterisation into a pipeline of independent classification components, the pipeline being specific to the product classification, each classification component of the pipeline being configured to independently generate digits of the tariff classification additional to the classification output of a classification component upstream in the pipeline, by iteratively performing:
selecting one of the multiple classification components based on a current classification of the product, and
applying the one of the multiple classification components to the product characterisation to update the current classification of the product;
the processor being further configured to, responsive to meeting a termination condition, outputting the current classification as a final classification of the product.

23. A method for classifying a product into a tariff classification, the tariff classification being represented by a node in a tree of nodes, each node being associated with a text string indicative of a semantic description of that node as a sub-class of a parent of that node, the method comprising:
iteratively classifying, at one of the nodes of the tree, the product into one of multiple child nodes of that node;
wherein the classifying comprises:
determining a set of features of the product that are discriminative for that node by extracting the features from the text string indicative of a semantic description of that node; and
determining a feature value for each feature of the product by extracting the feature value from a product characterisation, and
evaluating a decision model of that node for the determined feature values, the decision model being defined in terms of the extracted feature for that node.

24. The method of claim 23, wherein at a first iteration of classifying the product, the product is unclassified and classifying comprises classifying the product into one of multiple chapters of the tariff classification.

25. The method of claim 24, wherein classifying the unclassified product comprises applying a trained machine learning models to classify the unclassified product.

26. The method of any one of the claims 23 to 25, wherein a current classification at a node of the tree is represented by a sequence of multiple digits and digits of a later iteration define a classification deeper in the tree of nodes.

27. The method of claim 26, wherein classifying comprises one of:
classifying the product into a 2-digits chapter; and
classifying the product with a 2-digit classification into a 6-digit sub-heading.

28. The method of any one of the claims 23 to 27, wherein iteratively classifying comprises repeating the classifying until a termination condition is met.

29. The method of claim 28, wherein the termination condition comprises a minimum number of digits representing the classification.

30. The method of any one of the claims 23 to 29, wherein iteratively classifying comprises performing at least three classifications.

31. The method of any one of the claim 23 to 30, wherein classifying comprises:
converting the product characterisation into a vector;
test each of multiple candidate classifications in relation to the current classification against the vector; and
accept one of the multiple candidate classifications based on the test.

32. The method of any one of the claims 23 to 31, wherein extracting the feature value comprises evaluating a trained machine learning model, wherein the trained machine learning model has the product characterisation as an input, and the feature value as an output.

33. The method of any one of claims 23 to 32, wherein extracting the feature value comprises selecting one of multiple options for the feature value.

34. The method of claim 33, wherein the method further comprises determining the multiple options for the feature value from the text string indicative of a semantic description of that node.

35. The method of claim 33 or 34, wherein selecting the one of the multiple options for the feature value comprises:
calculating a similarity score indicative of a similarity between each of the options and the product characterisation; and
selecting the one of the multiple options with the highest similarity.

36. The method of any one of the claims 33 to 35, wherein the method further comprises:
calculating a similarity score indicative of a similarity between each of the options and the product characterisation;
presenting, in the user interface, multiple of the options that have the highest similarity to the user for selection; and
receiving a selection of one of the option by the user to thereby receive the feature value.

37. The method of any one of the claims 33 to 36, wherein the method further comprises applying a trained image classifier to an image of the product to select the one of the multiple options for the feature value.

38. The method of claim 37, wherein training the image classifier comprises:
receiving an indication of an image area from a user through a user interface,
receiving a label of the image from the user through the user interface, and
training the image classifier on the image area to the received label.

39. The method of claim 38, wherein the method further comprises:
determining a candidate image area automatically with reference to previously stored product images; and
presenting the candidate image area to the user for adjustment.

40. The method of any one of the claims 33 to 39, wherein the method further comprises performing natural language processing of the product characterisation to select the one of the multiple options for the feature value.

41. The method of any one of the claims 23 to 40, further comprising training the decision model according to a predefined schedule.

42. The method of any one of the claims 23 to 41, further comprising refining the decision model for a further product based on user input related to classifying the product.

43. Software that, when performed by a computer, causes the computer to perform the method of any one of the claims 23 to 42.

44. A computer system for classifying a product into a tariff classification, the tariff classification being represented by a node in a tree of nodes, each node being associated with a text string indicative of a semantic description of that node as a sub-class of a parent of that node, the computer system comprising a processor configured to:
iteratively classify, at one of the nodes of the tree, the product into one of multiple child nodes of that node;
wherein to classify comprises:
determining a set of features of the product that are discriminative for that node by extracting the features from the text string indicative of a semantic description of that node; and
determining a feature value for each feature of the product by extracting the feature value from a product characterisation, and
evaluating a decision model of that node for the determined feature values, the decision model being defined in terms of the extracted feature for that node.

45. A method for classifying a product into a tariff classification, the tariff classification being represented by a node in a tree of nodes, each node being associated with a text string indicative of a semantic description of that node as a sub-class of a parent of that node, the method comprising:
iteratively classifying, at one of the nodes of the tree, the product into one of multiple child nodes of that node;
wherein the classifying comprises:
determining whether a current assignment of feature values to features supports a classification from that node;
upon determining that the current assignment of feature values to features does not support the classification from that node on the path, selecting one of multiple unresolved features that results in a maximum support for downstream classification;
generating a user interface comprising a user input element for a user to enter a value for the selected one of the multiple non-valued features;
receiving a feature value entered by the user; and
evaluating a decision model of that node for the received feature value, the decision model being defined in terms of the extracted feature for that node.

46. The method of claim 45, wherein at a first iteration of classifying the product, the product is unclassified and classifying comprises classifying the product into one of multiple chapters of the tariff classification.

47. The method of claim 46, wherein classifying the unclassified product comprises applying a trained machine learning models to classify the unclassified product.

48. The method of any one of the claims 45 to 47, wherein a current classification at a node of the tree is represented by a sequence of multiple digits and digits of a later iteration define a classification deeper in the tree of nodes.

49. The method of claim 48, wherein classifying comprise one of:
classifying the product into a 2-digits chapter; and
classifying the product with a 2-digit classification into a 6-digit sub-heading.

50. The method of any one of the claims 45 to 49, wherein iteratively classifying comprises repeating the classifying until a termination condition is met.

51. The method of claim 50, wherein the termination condition comprises a minimum number of digits representing the classification.

52. The method of any one of the claims 45 to 51 wherein iteratively classifying comprises performing at least three classifications.

53. The method of any one of the claim 45 to 52, wherein classifying comprises:
converting the product characterisation into a vector;
test each of multiple candidate classifications in relation to the current classification against the vector; and
accept one of the multiple candidate classifications based on the test.

54. The method of any one of the claims 45 to 53, further comprising extracting the feature values by evaluating a trained machine learning model, wherein the trained machine learning model has the product characterisation as an input, and the feature value as an output.

55. The method of claim 54, wherein extracting the feature value comprises selecting one of multiple options for the feature value.

56. The method of claim 55, wherein the method further comprises determining the multiple options for the feature value from the text string indicative of a semantic description of that node.

57. The method of claim 55 or 56, wherein each of the multiple options is associated with one or more keywords and selecting one of the multiple options comprises matching the one or more keywords against the product characterisation and selecting the best matching option.

58. The method of claim 57, wherein the one or more keywords comprise a strong keyword that forces a selection of the associated option when matched.

59. The method of claim 57 or 58, wherein the one or more keywords are included in lists of keywords that are selectable by the user for each of the options.

60. The method of any one of the claims 57 to 58, wherein the user interface comprises automatically generated keywords or list of keywords for the user to select for each option.

61. The method of claim 60, wherein the method comprises automatically generating the keywords or list of keywords by determining one or more of:
synonyms;
hyponyms; and
lemmatization.

62. The method of claim 60 or 61, wherein the user interface presents the automatically generated keywords or list of keywords in hierarchical manner to reflect an hierarchical relationship between the keywords or list of keywords.

63. The method of any one of the claims 45 to 62, wherein
each classification is performed by a selected one of multiple classification components comprising a base-component and a refined-component;
the refined-component is associated with multiple options for the feature value that are inherited from the base-component; and
the user interface presents the multiple options and associated keywords with a graphical indication of which of the multiple options and associate keywords are inherited.

64. The method of any one of the claims 45 to 63, wherein selecting the one of the multiple options for the feature value comprises:
calculating a similarity score indicative of a similarity between each of the options and the product characterisation; and
selecting the one of the multiple options with the highest similarity.

65. The method of any one of the claims 45 to 64, wherein the method further comprises:
calculating a similarity score indicative of a similarity between each of the options and the product characterisation;
presenting, in the user interface, multiple of the options that have the highest similarity to the user for selection; and
receiving a selection of one of the option by the user to thereby receive the feature value.

66. Software that, when performed by a computer, causes the computer to perform the method of any one of the claims 45 to 65.

67. A computer system for classifying a product into a tariff classification, the tariff classification being represented by a node in a tree of nodes, each node being associated with a text string indicative of a semantic description of that node as a sub-class of a parent of that node, the computer system comprising a processor configured to:
iteratively classify, at one of the nodes of the tree, the product into one of multiple child nodes of that node;
wherein to classify comprises:
determining whether a current assignment of feature values to features supports a classification from that node;
upon determining that the current assignment of feature values to features does not support the classification from that node on the path, selecting one of multiple unresolved features that results in a maximum support for downstream classification;
generating a user interface comprising a user input element for a user to enter a value for the selected one of the multiple non-valued features;
receiving a feature value entered by the user; and
evaluating a decision model of that node for the received feature value, the decision model being defined in terms of the extracted feature for that node.
